(19) United States
(12) Patent Application Publication
(10) Pub. No.: US 2026/0169714 A1
(43) Pub. Date: Jun. 18, 2026

(54) HALLUCINATION MITIGATION TECHNIQUES FOR TEXT-TO-CODE CONVERSIONS

(71) Applicant: Optum, Inc., Minnetonka, MN (US)

(72) Inventors: Pankaj Sharma, Hyderabad (IN); Deepak Arora, Gurugram (IN); Swapnil G Desai, Gurgaon (IN)

(21) Appl. No.: 18/986,187

(22) Filed: Dec. 18, 2024

(51) Int. Cl. G06F 8/61

(52) U.S. Cl. CPC G06F 8/61

(57) ABSTRACT

Various embodiments of the present disclosure provide hallucination mitigation techniques for text-to-code conversions that improves the functionality of a computer in various aspects. The techniques comprise receiving a text-based file that defines a set of standards for a prediction domain; generating, using a machine learning model, a decision tree based on (i) the text-based file and (ii) a decisioning prompt for the text-based file; generating, using the machine learning model, computer programmable code for the set of standards based on the decision tree and a code conversion prompt for the decision tree; and providing the computer programmable code to implement an automated task for the prediction domain.

### BACKGROUND

In many domains, guidance may be released in a narrative text format that isn't natively useable by a computer and that may be released at a cadence that may result in multiple different forms of guidance being stored by a computer. These different guidance data files may not be duplicates but may pertain to a same issue or different permutations of an issue, resulting in increasing data storage usage and a growing big data problem to sort through and identify guidance that is relevant to a particular issue and context.

Various embodiments of the present disclosure make important contributions to both machine learning and automated, code conversion, technologies by addressing these technical challenges, among others. By doing so, the disclosed embodiments reduce conversion time, minimize human error, and improve the ability to rapidly incorporate updates into existing systems.

### BRIEF DESCRIPTION OF THE DRAWINGS

FIG. 1 depicts a block diagram of an example architecture in accordance with some embodiments of the present disclosure.

FIG. 2 depicts a block diagram of an example predictive data analysis computing entity in accordance with some embodiments of the present disclosure.

FIG. 3 depicts a block diagram of an example client computing entity in accordance with some embodiments of the present disclosure.

FIG. 4 is a flowchart diagram of an example text-to-code conversion process in accordance with some embodiments of the present disclosure.

FIG. 5 depicts an operational example of a decision tree in accordance with some embodiments of the present disclosure.

FIG. 6 depicts an operational example of a machine learning model architecture in accordance with some embodiments of the present disclosure.

FIG. 7 depicts an operational example of computer programmable code determined in accordance with some embodiments of the present disclosure.

FIG. 8 depicts a flowchart diagram of an example decision tree review process in accordance with some embodiments of the present disclosure.

FIG. 9 depicts a flowchart diagram of an example computer programmable code testing process in accordance with some embodiments of the present disclosure.

FIG. 10 depicts an operational example of a test case in accordance with some embodiments of the present disclosure.

FIG. 11 depicts a flowchart diagram of an example decision process in accordance with some embodiments of the present disclosure.

### DETAILED DESCRIPTION

Various embodiments of the present disclosure provide new machine learning models and staged processing pipelines that improve the functionality of computer systems with respect machine learning and automated conversion of narratives into technologies. To achieve this, some embodiments of the present disclosure provide a multi-stage processing pipeline that leverages a machine learning model, such as a transformer model, and a pipeline comprising the machine learning model, a process, and a set of tailored prompts to incrementally convert text (e.g., within a text-based file or other representation of a set of standards) to computer programmable code. The multi-stage processing pipeline directly addresses hallucinations as well as other technical challenges presented by transformer model architectures by sequentially converting text data structures (e.g., input text files) to a code data structure (e.g., computer programmable code) through an intermediate data structure (e.g., decision tree and/or a visual representation thereof, such as an image depicting a decision tree) that is designed to improve hallucination detection and mitigate such deficiencies as code is converted from an initial text input.

Historically, the process of converting a text-based file into computer programmable code has relied on manual conversion by human experts with specialized knowledge in both the subject matter of the text-based file and coding languages. The lack of availability of such individuals results in significant timing delays between the publication of new guidelines and their implementation within a computer. In addition to these timing and availability constraints, the manual nature of code conversion introduces risks of inconsistency, typographical errors, inherent biases, and other inaccuracies that compromise the accuracy and reliability of the resulting code. These challenges may be addressed by some transformer model architectures that may be trained to convert text to code. However, traditional transformer models are subject to several technical deficiencies that reduce their performance with respect to such tasks. Transformer models, for example, may be traditionally trained using natural language datasets with limited syntax examples of accurate code conversion tasks. This leads to syntax inaccuracies that reduce performance of the converted code. Moreover, traditional transformers are prone to introducing hallucinations in text-to-code conversions thereby reducing the accuracy of the converted code and may be fatal to the execution of the code and/or result in inaccurate results. Due to the complex and uninterpretable nature of code syntaxes, such hallucinations from traditional text-to-code conversion techniques may be difficult to identify, prevent, and/or resolve.

Embodiments of the present disclosure address these technical challenges through several innovative approaches. These include generation of a decision tree based on a text-based file and the creation of computer programmable code based on the decision tree. Additionally, the system incorporates quality assurance measures by generating test cases and synthetic data to confirm the functionality of the converted code. These technical advancements significantly reduce conversion time, minimize errors, and improve the ability to rapidly incorporate updates into existing systems, thereby enhancing the overall efficiency and reliability of the code conversion process.

More specifically, the staged processing pipelines of the present disclosure utilize a machine learning model, such as a transformer model, that is trained with historical text-based files, historical decision trees, and historical computer programmable code to automate the conversion process through a sequence of staged prompts. Once trained, the same model may be configured to covert input text to an interpretable intermediate output, such as a decision tree, that may provide explainable metadata for detecting and correcting hallucinations and/or other inaccuracies generated by the model. At the same time, the intermediate output may provide a structured representation of the input text that is more easily correlated to code syntaxes. The intermediate output is then used to produce computer programmable code. Thus, by generating the computer programmable code from the intermediate output, rather than the directly from the input text, the staged processing pipeline of the present disclosure may improve the model's conversion accuracy. This accuracy may be further enhanced by incorporating contextual data, such as code samples, syntax libraries, and/or code commands, into the input provided to the model to ensure the converted code aligns with established standards and practices. Ultimately, by leveraging the model in such a staged processing pipeline, the present disclosure enables automated conversion of complex unstructured text into standardized, computer programmable code. This approach overcomes limitations of traditional coding techniques by providing a flexible, continuously updatable system that may adapt to changes in text-based files over time. The automated generation of test cases and synthetic data further enhances the reliability and functionality of computer programmable code, ensuring its accuracy and completeness in various computational scenarios.

The techniques (e.g., hardware, software, machine-learned models, and/or a combination thereof) may reduce the number and impact of hallucinations by a transformer-based machine-learned model, thereby reducing software flaws and security issues and mitigating false positives or false negatives caused by incorrectly coded software. Moreover, the techniques may reduce storage that would typically be occupied by near-duplicate guidance and may reduce the time-to-live of the software that implements textual guidance after the textual guidance is received. Other technical improvements and advantages may be realized by one of ordinary skill in the art.

Various embodiments of the present disclosure are described more fully hereinafter with reference to the accompanying drawings, in which some, but not all embodiments of the present disclosure are shown. Indeed, the present disclosure may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “example” are used to be examples with no indication of quality level. Terms such as “computing,” “determining,” “generating,” and/or similar words are used herein interchangeably to refer to the creation, modification, or, in limited cases, identification of data. Further, “based on,” “based at least in part on,” “based at least on,” “based upon,” and/or similar words are used herein interchangeably in an open-ended manner such that they do not necessarily indicate being based only on or based solely on the referenced element or elements unless so indicated. Like numbers refer to like elements throughout.

### I. Overview of Embodiments

As should be appreciated, various embodiments of the present disclosure may be implemented as methods, apparatus, systems, computing devices, computing entities, computer program products, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may take the form of an entirely hardware embodiment, an entirely computer program product embodiment, and/or an embodiment that comprises a combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some embodiments, retrieval, loading, and/or execution are performed in parallel such that multiple instructions are retrieved, loaded, and/or executed together. Thus, such embodiments may produce specifically configured machines performing the steps or operations specified in the block diagrams and flowchart illustrations. Accordingly, the block diagrams and flowchart illustrations support various combinations of embodiments for performing the specified instructions, operations, or steps.

### II. Example Framework

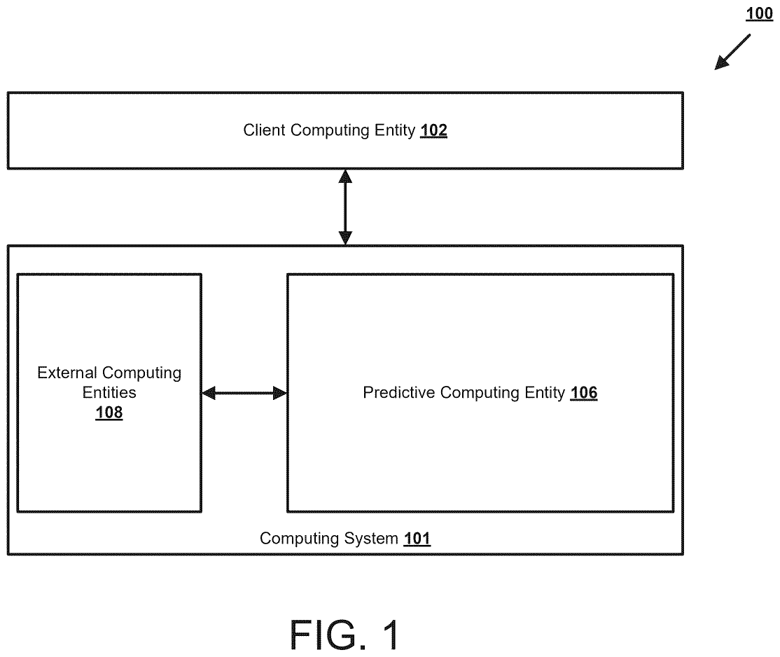

FIG. 1 depicts a block diagram of an example architecture in accordance with some embodiments of the present disclosure. The architecture 100 comprises a computing system 101 configured to receive a request, such as a prompt request, and/or the like, from client computing entities 102, process the request (e.g., by providing the request as input to a machine learning model), and provide responses (e.g., based on output generated by a machine learning model based on the request) to the client computing entities 102. The example architecture 100 may be used in a plurality of domains and is not limited to any specific application as disclosed herewith. The plurality of domains may comprise industrial, manufacturing, computer security, to name a few.

In some embodiments, the computing system 101 communicates with at least one of the client computing entities 102 using one or more communication networks. Examples of communication networks comprise any wired or wireless communication network including, for example, a wired or wireless local area network (LAN), personal area network (PAN), metropolitan area network (MAN), wide area network (WAN), or the like, as well as any hardware, software, and/or firmware required to implement it (such as, e.g., network routers, and/or the like).

The computing system 101 may comprise a predictive computing entity 106 and one or more external computing entities 108. The predictive computing entity 106 and/or one or more external computing entities 108 may be individually and/or collectively configured to receive requests from client computing entities 102, process the requests to generate code predictions, and provide the code predictions to the client computing entities 102.

For example, as discussed in further detail herein, the predictive computing entity 106 and/or one or more external computing entities 108 comprise storage subsystems that may be configured to store input data, training data, and/or the like that may be used by the respective computing entities to perform predictive data analysis and/or training operations of the present disclosure. In addition, the storage subsystems may be configured to store model definition data used by the respective computing entities to perform various predictive data processing and/or training tasks. The storage subsystem may comprise one or more storage units, such as multiple distributed storage units that are connected through a computer network. A storage unit in the respective computing entities may store at least one of one or more data assets and/or a set of data about the computed properties of one or more data assets. Moreover, each storage unit in the storage systems may comprise one or more non-volatile storage or volatile storage media similar to or different than the non-volatile and/or volatile computer-readable storage media discussed above.

In some embodiments, the predictive computing entity 106 and/or one or more external computing entities 108 are communicatively coupled using one or more wired and/or wireless communication techniques. The respective computing entities may be configured according to the techniques described herein to perform one or more operations of one or more techniques described herein. By way of example, the predictive computing entity 106 may be configured to train, implement, use (e.g., execute an inference operation(s)), update (e.g., finetune), and evaluate machine learning models in accordance with one or more training and/or inference operations of the present disclosure. In some examples, the external computing entities 108 may be configured to train, implement, use, update, and evaluate machine learning models in accordance with one or more training and/or inference operations of the present disclosure.

In some embodiments, the predictive computing entity 106 is configured to receive and/or transmit one or more datasets, objects, and/or the like from and/or to the external computing entities 108 to perform one or more steps/operations of one or more techniques (e.g., conversion techniques and/or computer programmable code generation techniques) described herein. The external computing entities 108, for example, may comprise and/or be associated with one or more entities that may be configured to receive, transmit, store, manage, and/or facilitate datasets, and/or the like. The external computing entities 108, for example, may comprise data sources that may provide such datasets, and/or the like to the predictive computing entity 106 which may leverage the datasets, such as historical text-based files, historical decision trees, or historical computer programmable code, to perform one or more steps/operations of the present disclosure, as described herein. In some examples, the datasets may comprise an aggregation of data from across a plurality of external computing entities 108 into one or more aggregated datasets. The external computing entities 108, for example, may be associated with one or more data repositories, cloud platforms, compute nodes, organizations, and/or the like, which may be individually and/or collectively leveraged by the predictive computing entity 106 to obtain and aggregate data for an information domain.

In some embodiments, the predictive computing entity 106 is configured to receive a trained machine learning model that is trained and subsequently provided by the one or more external computing entities 108. For example, the one or more external computing entities 108 may be configured to perform one or more training steps/operations of the present disclosure to train a machine learning model, as described herein. In such a case, the trained machine learning model may be provided to the predictive computing entity 106, which may leverage the trained machine learning model to perform one or more inference steps/operations of the present disclosure. In some examples, feedback (e.g., evaluation data, ground truth data) from the use of the machine learning model may be received and/or stored by the predictive computing entity 106. In some examples, the feedback may be provided to the one or more external computing entities 108 to continuously train the machine learning model over time. In some examples, the feedback may be leveraged by the predictive computing entity 106 to continuously train the machine learning model over time. In this manner, the computing system 101 may perform, via one or more combinations of computing entities, one or more prediction, training, and/or any other machine learning-based techniques of the present disclosure.

### A. Example Predictive Computing Entity

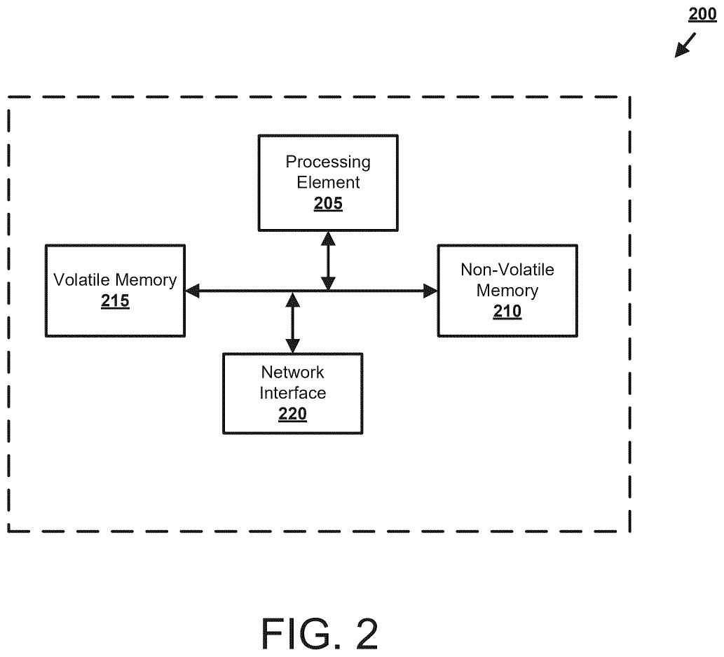

FIG. 2 depicts a block diagram of an example computing entity 200 in accordance with some embodiments of the present disclosure. The computing entity 200 is an example of the predictive computing entity 106 and/or external computing entities 108 of FIG. 1. In general, the terms computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may comprise, for example, transmitting, receiving, operating on, processing, displaying, storing, determining, creating/generating, training one or more machine learning models, monitoring, evaluating, comparing, and/or similar terms used herein interchangeably. In some embodiments, these functions, operations, and/or processes may be performed on data, content, information, and/or similar terms used herein interchangeably. In some embodiments, the one computing entity (e.g., predictive computing entity 106) may train and use one or more machine learning models described herein. In other embodiments, a first computing entity (e.g., predictive computing entity 106, which may be one or more predictive computing entities) may use one or more machine learning models that may be trained by a second computing entity (e.g., external computing entity 108) communicatively coupled to the first computing entity. The second computing entity, for example, may train one or more of the machine learning models described herein, and subsequently provide the trained machine learning model(s) (e.g., optimized weights, code sets) to the first computing entity over a network.

As shown in FIG. 2, in some embodiments, the computing entity 200 may comprise, or be in communication with, one or more processing elements 205 (also referred to as processors, processing circuitry, and/or similar terms used herein interchangeably) that communicate with other elements within the computing entity 200 via a bus, for example. As will be understood, the processing element 205 may be embodied in a number of different ways.

For example, the processing element 205 may be embodied as one or more complex programmable logic devices (CPLDs), microprocessors, multi-core processors, arithmetic logic units (ALUs) (e.g., which may be part of one or more graphics processing units (GPUs), tensor processing units (TPUs), and/or the like), coprocessing entities, application-specific instruction-set processors (ASIPs), microcontrollers, and/or controllers. Additionally, or alternatively, the processing element 205 may be embodied as one or more other processing devices and/or circuitry. The term circuitry may refer to an entirely hardware embodiment or a combination of hardware and computer program products. Examples of a combination of hardware and computer program products comprise application specific integrated circuits (ASICs), field programmable gate arrays (FPGAs), programmable quantum gate arrays, programmable logic arrays (PLAs), hardware accelerators, other circuitry, and/or the like. With respect to quantum computing embodiments of the computing entity 200, the processing element 205 may comprise specialized components for manipulating and measuring quantum states. These components may comprise quantum gates that perform operations on one or more qubits, quantum circuits that combine multiple gates to implement algorithms, measurement devices that extract classical information from quantum state, and/or the like. The quantum gates, circuits, and/or the like may be controlled, using one or more error correction mechanisms to compensate for decoherence and other quantum noise effects, to maintain quantum coherence while performing computations.

As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present disclosure when configured accordingly.

In some embodiments, the computing entity 200 may further comprise, or be in communication with, non-transitory computer readable media, such as non-volatile memory 210 (also referred to as non-volatile media, storage, memory storage, memory circuitry, and/or similar terms used herein interchangeably), volatile memory 215 (also referred to as volatile media, storage, memory storage, memory circuitry, and/or similar terms used herein interchangeably), quantum memory (e.g., solid quantum memory, atomic gas quantum memory), and/or the like.

In some embodiments, non-volatile memory 210 may comprise a computer-readable storage medium may comprise a floppy disk, flexible disk, hard disk, solid-state storage (SSS) (e.g., a solid-state drive (SSD), solid-state card (SSC), solid-state module (SSM)), enterprise flash drive, magnetic tape, or any other non-transitory magnetic medium, and/or the like. A non-volatile computer-readable storage medium may also comprise a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also comprise read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also comprise conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In some embodiments, volatile memory 215 may comprise a computer-readable storage medium including random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

In some embodiments, quantum memory comprises a memory structure that utilizes quantum bits, or qubits, which may exist in multiple states simultaneously through a property called superposition. Unlike classical bits that may only be in a state of 0 or 1, qubits may represent both states at once, allowing for exponentially larger information storage capacity. These quantum memory structures must maintain quantum coherence, which refers to the delicate quantum mechanical state of the system, while also allowing for rapid access and manipulation of stored quantum information.

As will be recognized, the non-volatile memory 210, the volatile memory 215, and/or the quantum memory may store respective part(s) of one or more databases, database instances, database management systems, data, applications, programs, program modules, scripts, code (e.g., source code, object code, byte code, compiled code, interpreted code, machine code) that embodies one or more machine learning models or other computer functions described herein, executable instructions, and/or the like being executed by, for example, the processing element 205. The term database, database instance, database management system, and/or similar terms used herein interchangeably, may refer to a collection of records or data that is stored in a computer-readable storage medium using one or more database models; such as a hierarchical database model, network model, relational model, entity-relationship model, object model, document model, semantic model, graph model, and/or the like.

Thus, the databases, database instances, database management systems, data, applications, programs, program modules, code (source code, object code, byte code, compiled code, interpreted code, machine code) that embodies one or more machine learning models or other computer functions described herein, executable instructions, and/or the like may be used to control certain aspects of the operation of the computing entity 200 by operating the processing element 205 according to software component(s) retrieved from any of the computer-readable storage media and executed by the processing element 205.

Embodiments of the present disclosure may be implemented in various ways, including as computer program products that comprise articles of manufacture. Such computer program products may comprise one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages comprise, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form, such as object code, or may be first transformed into another form, such as by compiling source code. A software component may be stored as a file or other data storage construct. Software components of a similar type or functionally related may be stored together such as, for example, in a particular directory, folder, or library. Software components may be static (e.g., pre-established, or fixed) or dynamic (e.g., created or modified at the time of execution).

A computer program product may comprise a non-transitory computer-readable storage medium storing one or more software components comprising application(s), program(s), program module(s), script(s), source code and/or compiler(s) for generating executable instructions such as object code using the source code, program code, object code, byte code, compiled code, interpreted code, machine code, executable instructions, and/or the like (e.g., executable instructions, instructions for execution, computer program products, program code, and/or similar terms used herein interchangeably). Such non-transitory computer-readable storage media comprise all computer-readable storage media (including volatile memory 215 and non-volatile memory 210). In some embodiments, the computer program product may be executed by the computing entity 200 and/or the client computing entity. For example, at least a first portion of the computer program product may be stored within the volatile memory 215 and/or non-volatile 210 of the computing entity 200. In addition, or alternatively, at least a second portion of the computer program product may be stored within the volatile and/or non-volatile memory of a client computing entity.

In some embodiments, one or more components of the present disclosure may be implemented using general and/or specialized quantum computers. For example, the computing entity 200 may comprise quantum memory and/or quantum processing elements, as described herein, that may be configured for general processing and/or specialized processing tasks. In some examples, the quantum memory and/or quantum processing elements of the computer entity 200 may be specialized for machine learning tasks. By way of example, large language models (LLMs) and other transformer networks may be specially designed for operation within a quantum environment by replacing weight matrices in self-attention and/or multi-layer perceptron layers of such models with one or more combinations of variational quantum circuits and/or a quantum-inspired tensor networks, such as a matrix product operator (MPO). In this way, LLM functionality may be enabled within a quantum environment by decomposing weight matrices through the application of tensor network disentanglers and MPOs. Similarly, quantum support vector machines, quantum neural networks, and/or any other machine learning architecture may be modified to a quantum environment for implementation by the computing entity 200. Thus, the machine learning architectures of the present disclosure may be configured for classical computer or quantum computers based on the embodiment.

As indicated, in some embodiments, the computing entity 200 may also comprise one or more network interfaces 220 for communicating with various computing entities (e.g., the client computing entity 102, external computing entities), such as by communicating data, code, content, information, and/or similar terms used herein interchangeably that may be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. In some embodiments, the computing entity 200 communicates with another computing entity for uploading or downloading data or code (e.g., data or code that embodies or is otherwise associated with one or more machine learning models). Similarly, the computing entity 200 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1X (1xRTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, IEEE 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the computing entity 200 may additionally or alternatively comprise, or be in communication with, one or more input elements/devices, such as input sensor(s). In some examples, the input sensor(s) may comprise one or more keyboards, pointing devices (e.g., mouse, trackpad), touch screens, cameras (e.g., infrared light camera, visual light camera), depth sensors (e.g., LIDAR, radar, stereo cameras), gyroscopes, location sensors (e.g., global positioning system (GPS), Hall effect sensor, laser doppler vibrometer), microphones, and/or the like. The computing entity 200 may additionally or alternatively comprise, or be in communication with, one or more output elements/devices (not shown), such as one or more speakers, visual display devices, haptic feedback devices, motion devices (e.g., electromechanically actuated devices), and/or the like.

### B. Example Client Computing Entity

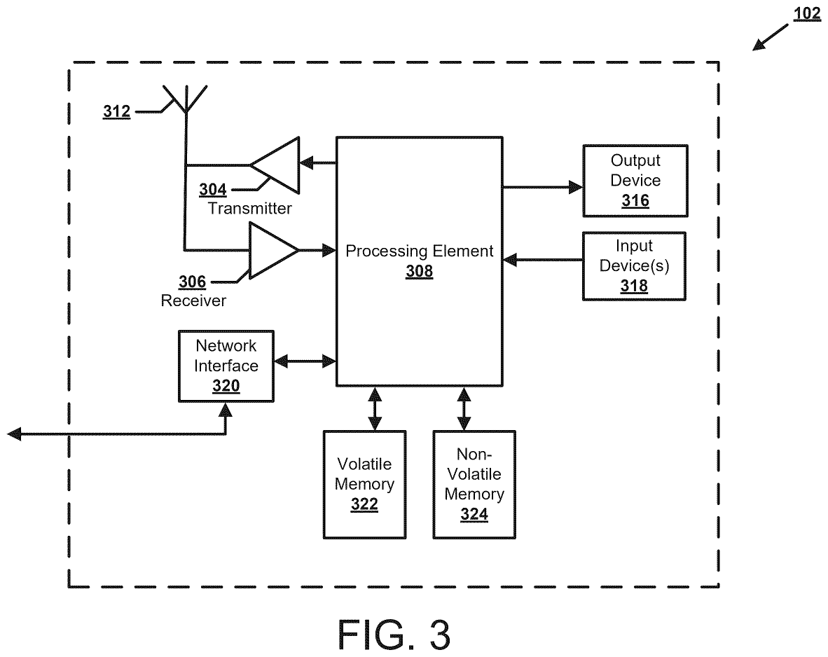

FIG. 3 depicts a block diagram of an example client computing entity in accordance with some embodiments of the present disclosure. In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Client computing entities 102 may be operated by various parties. As shown in FIG. 3, the client computing entity 102 may comprise an antenna 312, a transmitter 304 (e.g., radio), a receiver 306 (e.g., radio), and a processing element 308 (e.g., CPLDs, microprocessors, multi-core processors, coprocessing entities, ASIPs, microcontrollers, and/or controllers) that provides signals to and receives signals from the transmitter 304 and receiver 306, correspondingly.

The signals provided to and received from the transmitter 304 and the receiver 306, correspondingly, may comprise signaling information/data in accordance with air interface standards of applicable wireless systems. In this regard, the client computing entity 102 may be capable of operating with one or more air interface standards, communication protocols, modulation types, and access types. More particularly, the client computing entity 102 may operate in accordance with one or more wireless and/or wired communication standards and protocols, such as those described above with regard to the computing entity 200.

The client computing entity 102 may additionally or alternatively download code, changes, add-ons, and updates, for instance, to its firmware, software (e.g., including executable instructions, applications, program modules), and operating system.

According to some embodiments, the client computing entity 102 may comprise location determining aspects, devices, modules, functionalities, and/or similar words used herein interchangeably. For example, the client computing entity 102 may comprise outdoor positioning aspects, such as a location component adapted to acquire, for example, latitude, longitude, altitude, geocode, course, direction, heading, speed, universal time (UTC), date, and/or various other information/data. In some embodiments, the location component acquires data, sometimes known as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data may be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information/data may be determined by triangulating the position of the client computing entity 102 in connection with a variety of other systems, including cellular towers, Wi-Fi access points, and/or the like. Similarly, the client computing entity 102 may comprise indoor positioning aspects, such as a location component adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops), and/or the like. For instance, such technologies may comprise the iBeacons, Gimbal proximity beacons, Bluetooth Low Energy (BLE) transmitters, NFC transmitters, and/or the like. These indoor positioning aspects may be used in a variety of settings to determine the location of someone or something to within inches or centimeters.

The client computing entity 102 may also comprise a user interface that may comprise an output device 316 coupled to a processing element 308 and/or a user input device 318 coupled to the processing element 308. An output device 316, for example, may comprise a hardware computing device comprising one or more output elements (not shown), such as one or more speakers, visual display devices, haptic feedback devices, motion devices (e.g., electromechanically actuated devices), and/or the like. A user input device 318 may comprise the same or different hardware computing device comprising one or more input elements (not shown), such as keyboards, pointing devices (e.g., mouse, trackpad), touch screens, cameras (e.g., infrared light camera, visual light camera), depth sensors (e.g., LIDAR, radar, stereo cameras), gyroscopes, location sensors (e.g., global positioning system (GPS), Hall effect sensor, laser doppler vibrometer), microphones, and/or the like.

In some examples, the user interface may additionally or alternatively comprise software component(s) executed by the processing element 308 to present (e.g., audibly, visually, tactilely) via a user input device 318 and/or output device 316 and/or a software endpoint such as an application programming interface (API) or exposed software function a graphical user interface (GUI) (e.g., at least a portion of a user application, browser), command-line interface, touch and/or haptic user interface, gesture and/or image capture-based interface, voice/audio user interface, and/or the like used herein interchangeably executing on and/or accessible via the client computing entity 102 to interact with and/or cause display of information/data from the computing entity 200, as described herein. In addition to providing input, the user input interface may be used, for example, to activate, deactivate, and/or modify certain functions, such as altering a power or operating state of the client computing entity 102, the computing system 101, the predictive computing entity 106, and/or the external computing entity 108.

The client computing entity 102 may further comprise, or be in communication with, one or more memory components, such as the volatile memory 322 and/or non-volatile memory 324. For example, the memory components may comprise non-transitory computer readable media, such as non-volatile memory 324 (also referred to as non-volatile storage, memory, memory storage, memory circuitry, and/or similar terms used herein interchangeably) and/or volatile memory 322 (also referred to as volatile storage, memory, memory storage, memory circuitry, and/or similar terms used herein interchangeably), as discussed above with reference to FIG. 2.

As will be recognized, the non-volatile memory 324 and/or the volatile memory 322 may store respective part(s) of one or more databases, database instances, database management systems, data, applications, programs, program modules, scripts, code (e.g., source code, object code, byte code, compiled code, interpreted code, machine code) that embodies one or more machine learning models or other computer functions described herein, executable instructions, and/or the like being executed by, for example, the processing element 308. The term database, database instance, database management system, and/or similar terms used herein interchangeably, may refer to a collection of records or data that is stored in a computer-readable storage medium using one or more database models; such as a hierarchical database model, network model, relational model, entity-relationship model, object model, document model, semantic model, graph model, and/or the like.

In another embodiment, the client computing entity 102 may comprise one or more components or functionalities that are the same or similar to those of the computing entity 200, as described in greater detail above. In one such embodiment, the client computing entity 102 downloads, e.g., via network interface 320, code embodying machine learning model(s) from the computing entity 200 so that the client computing entity 102 may run a local instance of the machine learning model(s). As will be recognized, these architectures and descriptions are provided for example purposes only and are not limited to the various embodiments.

In various embodiments, the client computing entity 102 may be embodied as an artificial intelligence (AI) computing entity (e.g., an intelligent agent machine-learned model), such as AutoGPT, Mycroft, Rhasspy, and/or the like. Accordingly, the client computing entity 102 may be configured to provide and/or receive information/data from a user via an input/output mechanism, such as a display, a camera, a speaker, a voice-activated input, and/or the like. In certain embodiments, an AI computing entity may comprise one or more predefined and executable program algorithms stored within an onboard memory storage component, and/or accessible over a network. In various embodiments, the AI computing entity may be configured to retrieve and/or execute one or more of the predefined program algorithms upon the occurrence of a predefined trigger event.

### III. Example System Operations

As indicated, various embodiments of the present disclosure make important technical contributions to converting unstructured complex textual information, in the form of a text-based file, into standardized computer programmable code. In particular, systems and methods are disclosed herein that implement a multi-stage machine learning pipeline to convert complex textual information into computer programmable code through a multi-stage processing technique designed to mitigate hallucinations while improving machine learning explainability. To do so, an intermediate decision tree may be generated as a bridge between text and code and the interpretability of the intermediate decision tree may be leveraged to improve the explainability and hallucination control of the final code outputs of a machine learning model. In this way, the machine learning techniques of the present disclosure enable processing of unstructured, complex textual information into computer programmable code that may be executed by processors of a computer to accurately perform an automated task as specified by the complex textual information. This, in turn, may improve the functionality of a computer with respect to various computing tasks, including data encoding and decoding (e.g., parsing, via one or more transformer models, a text-based file into a decision tree and/or converting a decision tree to computer programmable code), machine learning training, natural language processing, and the like.

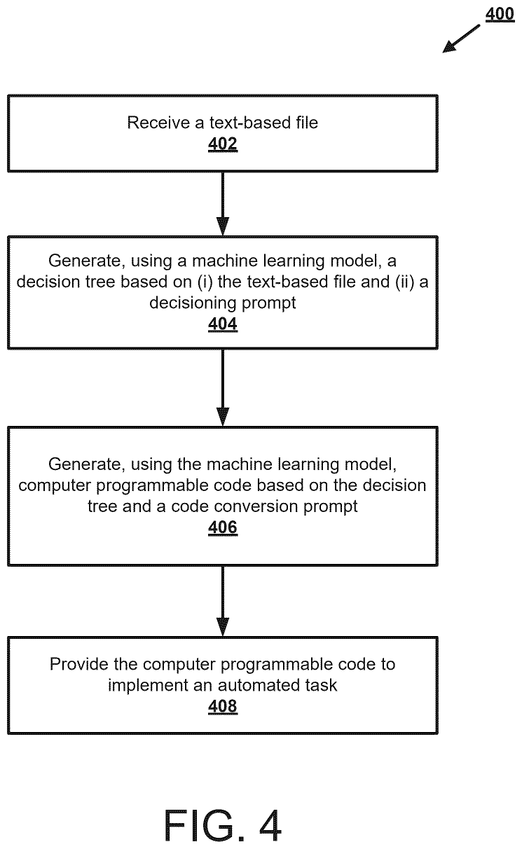

FIG. 4 is a flowchart diagram of an example text-to-code conversion process 400 in accordance with some embodiments of the present disclosure. The flowchart diagram depicts a multi-stage processing pipeline that improves the functionality of computer systems with respect machine learning and automated, code conversion, technologies. The process 400 may be implemented by one or more computing devices, entities, and/or systems described herein. For example, via the various operations of the process 400, the computing system 101 may sequentially process, extract, parse, and/or convert text data to computer programmable code through an intermediate decision tree data structure. By doing so, the computing system 101 may leverage a structured decision tree, as an intermediate output, to improve the interpretability and hallucination control of output generated by the machine learning models for verification and/or validation.

FIG. 4 illustrates an example process 400 for explanatory purposes. Although the example process 400 depicts a particular sequence of steps/operations, the sequence may be altered without departing from the scope of the present disclosure. For example, some of the steps/operations depicted may be performed in parallel or in a different sequence that does not materially impact the function of the process 400. In other examples, different components of an example device or system that implements the process 400 may perform functions at substantially the same time or in a specific sequence.

In some embodiments, the process 400 comprises, at operation 402, receiving a text-based file. For example, the computing system 101 may receive a text-based file that defines a set of standards for a prediction domain. Examples of the prediction domain may include financial systems, clinical systems, autonomous systems, robotic systems, and/or the like. In some embodiments, the text-based file comprises a set of standards, details, or information that is identified from a monitored data source. In some embodiments, receiving the text-based file further comprises (i) detecting from a set of data sources that the text-based file has newly been added to or modified at one of the set of data sources and (ii) receiving the text-based file based on identifying the text-based file as a new or modified text-based file.

In some embodiments, a text-based file comprises information that is associated with a process or procedure. For example, a text-based file may be representative of a narrative guideline including one or more decision paths. For example, a text-based file may comprise one or more questions or tests and one or more actions that may be taken based on the outcomes of the one or more questions or tests. In some embodiments, a text-based file further comprises non-text objects, such as images, tables, graphs, and/or multimedia file objects. For example, a text-based file may comprise text (e.g., strings and/or characters) as well as non-text objects that provide contextual data associated with the text. In some embodiments, the non-text objects may be extractable as text.

A text-based file may be implemented in various technical aspects of computing systems. For example, a text-based file may be stored in databases, such as relational databases, graph databases, and/or the like, to facilitate efficient retrieval and processing. The structure of a text-based file may be optimized to represent a hierarchical or branching nature of one or more decision paths. Additionally, a text-based file may be encoded in machine-readable formats to enable seamless integration with various software applications and systems.

In some examples, a text-based file comprises data, information, or instructions in a natural language format that is incompatible with, but otherwise may be useful if implemented in, expert systems, decision support systems, or artificial intelligence algorithms to guide automated decision-making processes. These systems may employ techniques, such as rule-based reasoning, decision trees, or Bayesian networks to navigate through decision paths reflected by natural language in a text-based file. As such, the implementation of logic based on text-based files in computing systems may allow for consistent and scalable application of complex decision-making processes across various scenarios and use cases.

Functionally, a text-based file may serve as a blueprint for guiding actions or choices in specific contexts. For example, a text-based file may enable systematic evaluation of conditions or criteria to determine appropriate responses or outcomes. Such a structured approach to decision-making may be particularly valuable in fields, such as healthcare, finance, or legal domains, where consistent and evidence-based decision-making is crucial.

Alternative embodiments or uses of a text-based file may comprise its application in machine learning models, where it may serve as training data to develop predictive algorithms. Additionally, a text-based file may be used in the development of interactive decision support tools, allowing users to navigate complex decision processes through user-friendly interfaces.

In some embodiments, a text-based file may be associated with a new publication or update that is automatically identified and retrieved for subsequent steps in a process (e.g., for processing, extracting, parsing, and/or converting a text-based file into computer programmable code).

A text-based file represents a technical challenge in maintaining up-to-date and comprehensive decision-making systems that may be in response to new research, updated guidelines, or evolving best practices that have not yet been incorporated into existing software systems. The identification and integration of a text-based file may comprise data mining and natural language processing techniques to extract information from unstructured sources, such as scientific papers, policy documents, or expert opinions.

A text-based file may be initially stored in temporary databases or data lakes, where it undergoes preprocessing and validation before integration into production systems. Preprocessing may comprise data cleansing, normalization, and transformation to ensure compatibility with existing data structures and decision-making algorithms. Machine learning techniques, such as text classification and named entity recognition, may be employed to automatically categorize and extract relevant information from discovered content.

A text-based file may be an initial input for enhancing and updating existing decision-making processes. A text-based file, for example, may serve as a crucial input for keeping automated systems aligned with the latest knowledge and practices in their respective domains. By incorporating a text-based file, systems may adapt to changing conditions, improve accuracy, and maintain relevance in dynamic environments. In addition, or alternatively, a text-based file may be leveraged in continuous learning systems, where it serves as fresh training data to refine and improve machine learning models iteratively.

In some embodiments, the process 400 comprises, at operation 404, generating, using a machine learning model, a decision tree based on (i) the text-based file and (ii) a decisioning prompt for the text-based file. For example, the computing system 101 may generate, using a machine learning model, a decision tree based on (i) the text-based file and (ii) a decisioning prompt for the text-based file. In some embodiments, a decisioning prompt describes instructions that are provided to a machine learning model for processing, extracting, parsing, and/or converting a text-based file to a decision tree. In some embodiments, a decisioning prompt comprises a reference to the text-based file and a decision tree format or structure. In some embodiments, a decisioning prompt comprises examples (e.g., few shot prompts) of decisions trees to guide a machine learning model on the format and content of the decision tree.

In some embodiments, a decision tree describes a data object or structure comprising text data from a text-based file that is formatted in a structured format (e.g., a tree structure, a knowledge graph structure). For example, a decision tree may comprise a directed graph with (i) nodes that represent a condition and/or decision point and (ii) edges that represent transitions and/or selected decisions between the nodes.

Additionally or alternatively, the techniques described herein may comprise generating a decision tree image (e.g., an image file depicting a representation of a decision tree, such as a portable network graphics (PNG), graphics interchange format (GIF), joint photographic experts group (JPEG), tagged image file (TIFF), portable document format (PDF), encapsulated postscript (EPS), raw image format (RAW), etc.).

In some embodiments, generating the decision tree further comprises deconstructing and/or partitioning the text-based file. For example, a text-based file comprising a large and/or complex document may be parsed and/or extracted into related parts (e.g., via a clustering algorithm), organized in a structured data format, and/or re-consolidated/re-constructed into a text-based file that interpretable by the machine learning model for conversion into computer programmable code. As such, the text-based file may be provided as structured data inputs to the machine learning model to derive accurate and/or holistic decision trees for capturing desired features.

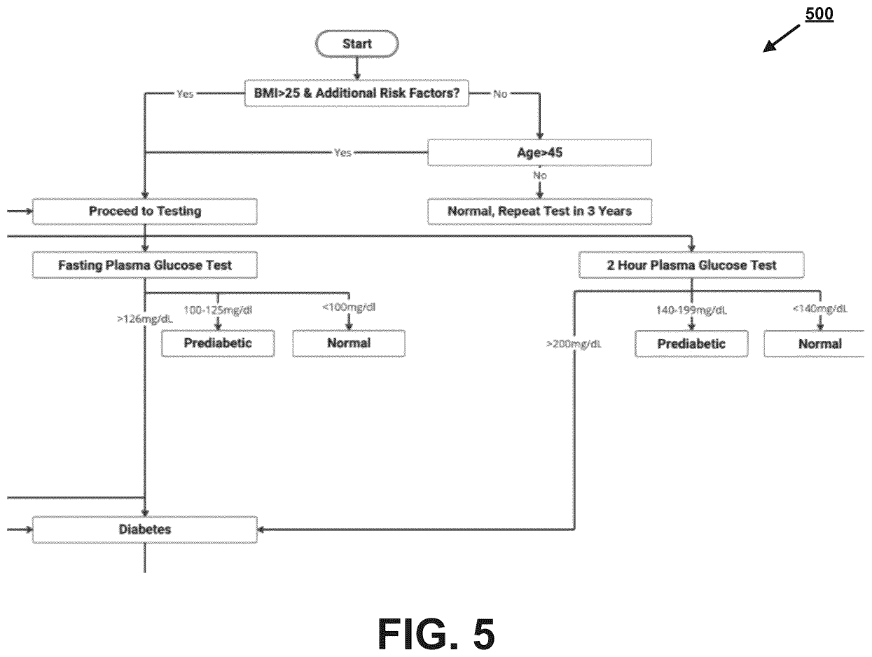

FIG. 5 depicts an operational example of a portion of decision tree 500 in accordance with some embodiments of the present disclosure. The decision tree 500 may represent a technical approach to encoding hierarchical decision-making processes in a format that bridges human-readable text and machine-processable structures. From a data structure perspective, decision tree 500 may be implemented as a nested JSON or XML document, where each node represents a decision point, and child nodes represent possible outcomes or subsequent decisions. Alternatively, decision tree 500 may be stored in a specialized graph database that efficiently captures the tree-like structure of a decision process.

In some examples, decision tree 500 may be implemented using domain-specific languages (DSLs), markup languages, and/or any other language that comprises syntax for specifying conditions, actions, branching logic, and/or the like, while maintaining explainability. In some examples, decision tree 500 may be associated with metadata, such as version information, authorship, or timestamps, and/or the like to facilitate tracking and auditing of changes to decision tree 500.

The decision tree 500 may serve as an intermediate representation that facilitates the transformation from a text-based file to computer programmable code. Decision tree 500 may provide a structured format that may be easily parsed by algorithms for various purposes, such as visualization, analysis, or code generation. Accordingly, decision tree 500 may provide a representation that allows for efficient traversal of decision paths, enabling quick evaluation of complex decision scenarios.

The decision tree 500 may represent an output generated by one or more processors performing an advanced natural language processing task, where complex text-based files (which may be either structured or unstructured) are processed, extracted, parsed, and/or converted into a structured machine-readable format. For example, decision tree 500 may be generated from a text-based file by leverage the capabilities of machine learning models, which excel at understanding context and generating structured output from natural language input. The generation of decision tree 500 may comprise a multi-step pipeline. For example, the text-based file may be tokenized and encoded into a format suitable for input to the machine learning model. The machine learning model may then process such input, leveraging its attention mechanisms to identify key decision points, conditions, and outcomes. The output of the machine learning model may then be post-processed to ensure that it adheres to specific structure and syntax requirements of a decision tree format.

A decision tree may serve as a bridge between human-authored guidelines and computational systems. By doing so, a decision tree may enable the automated extraction of decision logic from text-based files, facilitating rapid updates to decision support systems without manual intervention. This automation significantly reduces the time and potential for errors associated with the automated processing, extraction, parsing, and/or conversion of complex text-based files to generate computer interpretable data structures. In addition, or alternatively, a decision tree may be leveraged in automated compliance checking, where new regulations or policies may be quickly converted into a format that allows for systematic evaluation of existing processes against updated requirements.

According to various embodiments of the present disclosure, the decision tree may comprise an intermediary format that is generated in a process for converting the text-based file into computer programmable code. A decision tree may allow the machine learning model to more accurately characterize information or extract features from the text-based file. That is, a machine-based conversion from a text-based file to a decision tree may comprise an unstructured text-to-structured text transformation, whereas a machine-based conversion from a text-based file to computer programmable code may comprise an unstructured text-to-code transformation. A machine learning model may be able to more accurately convert a text-based file into a decision tree than directly into computer programmable code due to possible losses from an unstructured text-to-code transformation. For example, the computer programmable code may comprise a format or language that is difficult for the machine learning model to generate directly from a text-based file that may comprise unstructured text.

In some embodiments, computer programmable code includes a set of instructions configured in a programming language syntax that is executable by one or more processors to perform a task. Computer programmable code may represent the unit of code within a software system that may encompass a wide range of technical implementations and paradigms. In some embodiments, computer programmable code comprises sequences of instructions that are interpretable or compliable into a machine-executable format. These instructions may be formatted in various programming languages, each with its own syntax, semantics, and level of abstraction from the underlying hardware.

Computer programmable code may be implemented in one or more different syntax, including high-level languages, such as Python, Java, or C++ and/or the like (e.g., to improve readability, portability), low-level languages, such as assembly languages and/or the like (e.g., to improve control over hardware resources), domain-specific languages (DSLs), and/or the like. In some examples, the coding syntax may depend on one or more target parameters, such as performance requirements, a target platform for execution, a development ecosystem, and/or the like. In this manner, computer programmable code may serve as the means by which abstract algorithms and logical processes (e.g., as reflected by text) may be translated into actionable instructions for particular computing environment. Computer programmable code may enable the creation of applications, systems, and tools that may perform a vast array of tasks, from simple calculations to complex data analysis and decision-making processes.

As described herein, the decision tree 500 may be generated by applying a machine learning model to a text-based file. In some embodiments, a machine learning model refers to a data construct that describes parameters, hyperparameters, and/or defined operations for generating text in accordance with one or more data structures based on an input prompt. In some embodiments, a machine learning model is based on a transformer architecture that utilizes self-attention mechanisms to process and generate sequential data with high efficiency and effectiveness. In some embodiments, a machine learning model comprises a pre-trained large language model that is finetuned using a training dataset that comprises a plurality of training entries. A training entry, for example, may comprise one or more of (i) a historical text-based file, (ii) a historical decision tree corresponding to the historical text-based file, and/or (iii) historical computer programmable code corresponding to the historical text-based file. By way of example, the machine learning model may comprise a large-scale neural network with a plurality of parameters that is implemented using one or more deep learning frameworks, such as PyTorch, TensorFlow, and/or the like. In some examples, the deep learning frameworks may leverage distributed training techniques to handle the computational demands of training on large datasets.

The machine learning model used to generate decision tree 500 may be pre-trained using one or more machine learning training techniques, such as unsupervised or semi-supervised pretraining on a large corpora of text, followed by supervised finetuning on a specific task of converting text-based files into decision trees. In some embodiments, supervised finetuning comprises techniques, such as transfer learning, where a model pretrained on general language understanding tasks may be adapted to a specific decision tree generation task. In some embodiments, a machine learning model architecture (e.g., of a transformer model) comprises separate encoder and decoder components, allowing it to process input (such as a text-based file) and generate output (such as decision tree representations) in an end-to-end manner. In this manner, the machine learning model may automate the conversion of complex text-based files into decision trees).

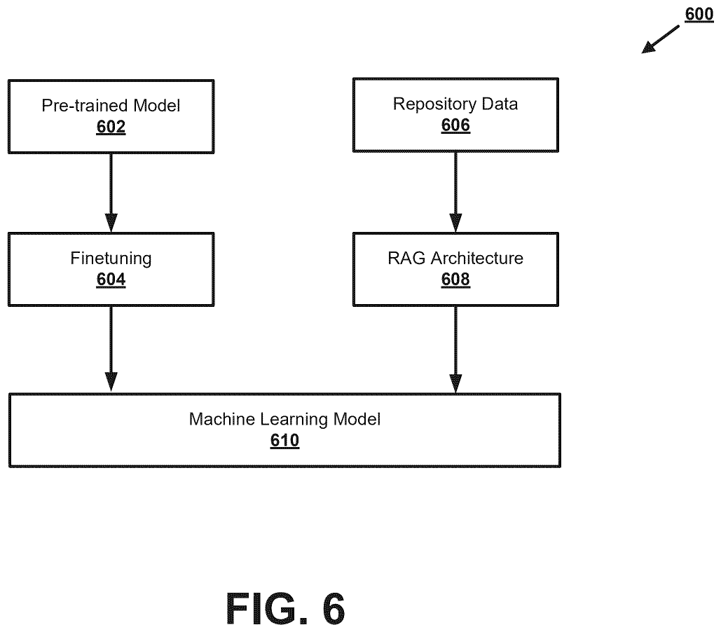

FIG. 6 depicts an operational example of a machine learning model architecture 600 in accordance with some embodiments of the present disclosure. As depicted, a pre-trained model 602 may be provided to a finetuning module 604 to generate the machine learning model 610. In some embodiments, the pre-trained model 602 comprises a generative machine learning model, such as a large language model, that is trained to perform a broad range of tasks. The finetuning module 604 may further refine the pre-trained model 602 to perform more specific tasks, such as generating (i) a decision tree and (ii) computer programmable code based on the decision tree, as disclosed herewith. In some embodiments, the finetuning module 604 further trains (e.g., finetune) the pre-trained model 602 to (i) generate decision trees based on text-based files and/or (ii) generate computer programmable code based on decision trees. The pre-trained model 602 may be trained based on (i) one or more historical text-based files, (ii) one or more historical decision trees, and/or (iii) historical computer programmable code.

In some embodiments, a historical text-based file describes a text-based file that is used to train a machine learning model. In some examples, a historical text-based file may be included in a training dataset comprising pairs of input-output examples. The input may comprise a text-based file, such as narrative guidelines or textual descriptions of decision processes, while the output may represent the corresponding historical decision tree structures or historical computer programmable code segments. In some embodiments, a historical decision tree describes a decision tree that is used to train a machine learning model. In some examples, a historical decision tree may be included in a training dataset comprising pairs of input-output examples. For example, the historical decision tree may include an output of the input-output example that corresponds to text-based file input. Another example output may include historical computer programmable code that respectively corresponds to one or more different coding syntaxes.

In some embodiments, a training dataset comprises a plurality of input-output pairs in a specialized format optimized for machine learning, such as TFRecord files for TensorFlow or PyTorch datasets, and/or the like. The specialized formats may allow for efficient data loading and processing during a training phase of the machine learning model. In some embodiments, a historical text-based file is prepared by using data augmentation techniques to increase the diversity and robustness of a training set generated therewith, as well as targeted curation to ensure the quality and representativeness of training examples.

The training dataset may be used to configure the machine learning model for converting an input, text-based file to one of a plurality of different outputs (e.g., a decision tree, computer programmable code). For example, the training dataset may be leveraged to train the machine learning model to learn a mapping between natural language descriptions and structured decision trees, as well as a translation of the natural language descriptions and structured decision trees into valid, efficient code.

In some examples, a training dataset may be generated through a targeted curation and annotation process. In some embodiments, expert knowledge is applied to ensure that historical decision trees of a training dataset accurately represent a wide range of decision-making scenarios and adhere to best practices in decision tree design. Historical decision trees may be stored in specialized formats that preserve their hierarchical structure while allowing for efficient batch processing during model training. Additionally, or alternatively, historical decision trees may be augmented with metadata, such as complexity scores or domain classifications to enable more nuanced training strategies. In some examples, the training dataset may be continuously augmented with new input-output pairs by adding input text-based files, and their verified decision trees, as they processed by the machine learning model.

In some embodiments, the machine learning model 610 comprises a link or communication connection with repository data 606 via the retrieval augmented generation (RAG) architecture 608 to provide contextual data that may be used to enrich queries or prompts provided to the machine learning model 610 with relevant context which in turn may help generate relevant responses. In some embodiments, the RAG architecture 608 comprises a software architecture that enhances the accuracy and relevance of output (e.g., computer programmable code) generated by the machine learning model 610 with the repository data 606. In particular, the RAG architecture 608 may optimize the output of the machine learning model 610 such that the machine learning model 610 may reference authoritative knowledge data comprising the repository data 606, outside of a training dataset used to train the machine learning model 610, before generating the output. For example, the RAG architecture 608 may extend the capabilities of the machine learning model 610 to a specific domain or knowledge base associated with the repository data 606.

In some embodiments, the RAG architecture 608 retrieves contextual data via semantic searches of the repository data 606 based on prompts received by the machine learning model 610 and supplements the prompts with the contextual data. In some embodiments, the RAG architecture 608 may comprise an encoder component of a machine learning model that is configured to generate embeddings (e.g., contextual data embeddings) of the repository data 606. For example, embeddings may be generated for at least a portion of the repository data 606 to map the repository data 606 to a high-dimensional vector space prior to providing a prompt to the machine learning model 610. The high-dimensional vector space may then be used to generate an embedding (e.g., prompt embedding) of a prompt that is provided to the machine learning model such that the semantic meaning of the prompt may be represented by the embedding based on a same vector space as the repository data 606. As such, the RAG architecture 608 may compare the embedding of the prompt with the embeddings of the repository data 606 in the vector space and determine selected portions (e.g., computer programmable code, syntax libraries, domain-specific commands) of the repository data 606 based on similarity scores (e.g., cosine similarity). The selected portions of the repository data 606 may be used to generate contextual data, which may be used to provide supplemental context or knowledge to machine learning model 610 for generating a response to the prompt. As such, the contextual data may allow the machine learning model 610 to generate a more accurate response (e.g., computer programmable code) to the prompt by associating the response with the repository data 606.

In some embodiments, generating contextual data comprises (i) generating (e.g., by using an encoder component of a machine learning model that is associated with the repository data 606) a prompt embedding based on a prompt (e.g., code conversion prompt) that is provided to the machine learning model 610, (ii) retrieving or access contextual data embeddings (e.g., previously generated by using the same encoder component of the machine learning model that is associated with the repository data 606) that are associated with data from the repository data 606, (iii) comparing the prompt embedding with the contextual data embeddings by determining a distance (such as Euclidean, Cosine similarity, etc.) between the prompt embedding and each of the contextual data embeddings, and (iv) identifying a subset of the contextual data embeddings that are most similar to the prompt embedding (e.g., up to a threshold number of contextual data instances within a threshold distance or closest to the embedding of the query or prompt in an embedding space). As such, specific contextual data respectively corresponding to the identified and/or retrieved embeddings of the contextual data may be provided along with (or used to augment) the query or prompt provided to the machine learning model 610.

In some embodiments, the RAG architecture 608 is leveraged, by the computing system 101 to further refine model outputs of the machine learning model 610 after the machine learning model is trained, without retraining the machine learning model 610. Supplementing queries or prompts with retrieved data from the repository data 606 may comprise prompt engineering techniques to communicate effectively with the machine learning model 610. As such, augmented prompts may allow the machine learning model 610 to generate accurate output. Accordingly, the RAG architecture 608 may comprise a cost-effective approach to improving output generated by the machine learning model 610 such that the output is relevant, accurate, and useful in specific contexts.

By way of example, the repository data 606 may comprise data from a storage of computer programmable code, such as a code repository. A code repository may comprise a centralized and version-controlled collection of software artifacts that serve as a reference point for an organization's codebase. In some embodiments, a code repository comprises computer programmable code comprising coding standards, library specifications, and/or target language requirements that are representative of desired characteristics for output generated by machine learning model 610. In some embodiments, a code repository is implemented using distributed version control systems which provide robust mechanisms for tracking changes, managing branches, and facilitating collaborative development. In some embodiments, a code repository is used as a basis of comparison for identifying a text-based file from one of a plurality of targeted data sources as a new or modified text-based file. Within a code repository, historical computer programmable code may be organized into projects or modules, each with its own directory structure, dependency management, and build configurations.

Turning back to FIG. 4, in some embodiments, the process 400 comprises, at operation 406, generating, using the machine learning model, computer programmable code for the set of standards based on the decision tree and a code conversion prompt for the decision tree. For example, the computing system 101 may generate, using the machine learning model, computer programmable code for the set of standards based on the decision tree and a code conversion prompt for the decision tree. Computer programmable code may comprise instructions that are stored on a computer-readable storage medium and executed to perform certain steps or operations. For example, computer programmable code may comprise query languages that specify procedures for accessing information from a database. In some embodiments, computer programmable code comprises query languages that are specific to specific domains, industries, and/or fields. That is, a query language may be used to express logic in specific use cases and/or applications, such as clinical quality language (CQL) that is based on the fast healthcare interoperability resources (FHIR) standard. In some embodiments, the computer programmable code comprises standards-based computer programmable code that are specific to certain domains, industries, and/or fields.

In some embodiments, operation 404 is optional and a decision tree need not be generated. Accordingly, in some embodiments, the process 400 comprises, at operation 406, generating, using the machine learning model, computer programmable code for the set of standards based on at least a portion of the text-based file. For example, an entirety or a portion of a text-based file may be directly converted into computer programmable code based on one or more complexity criteria, such as amount of text, file size, number of conditional statements and/or logic, etc. In some embodiments, generating the computer programmable code further comprises deconstructing and/or partitioning the text-based file. For example, a text-based file comprising a large and/or complex document may be parsed and/or extracted into related parts (e.g., via a clustering algorithm), organized in a structured data format, and/or re-consolidated/re-constructed into a text-based file that is easier to interpret by the machine learning model for conversion into computer programmable code.

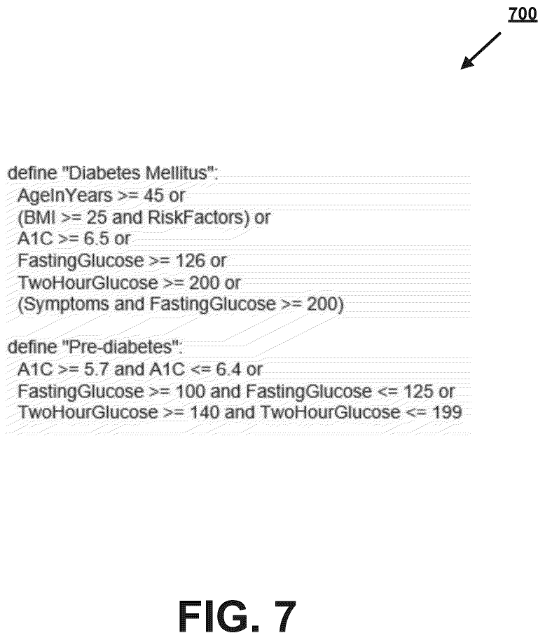

FIG. 7 depicts an operational example of computer programmable code 700 determined in accordance with some embodiments of the present disclosure. In some embodiments, the computer programmable code 700 represents an advanced application of artificial intelligence in software development, specifically in the domain of automated code generation. That is, the capabilities of machine learning models, which may be proficient in understanding and generating both natural language and programming language constructs, may be leveraged to generate the computer programmable code 700.

In some embodiments, the generation of computer programmable code 700 comprises a processing pipeline. A machine learning model may receive as input a decision tree, which may provide the logical structure of a decision-making process, along with a code conversion prompt which may comprise contextual data that specifies coding standards, library specifications, or target language requirements. The machine learning model may then generate code that implements a decision tree logic while adhering to the specified programming language syntax and best practices. For example, techniques, such as beam search or nucleus sampling, may be used to generate multiple code candidates, followed by a filtering or ranking process to select the most appropriate and efficient implementation. Additionally, static code analysis tools may be incorporated to ensure that the computer programmable code 700 meets quality and security standards.

The computer programmable code 700 may serve as a bridge between high-level decision-making logic and executable software components and enables rapid prototyping and implementation of complex decision systems, potentially reducing development time and minimizing human errors in the translation of natural language text-based logic to code.

According to various embodiments of the present disclosure, a computer programmable code generation process (e.g., via a machine learning model) is finetuned to produce computer programmable code in various programming languages or paradigms, allowing for flexibility in integration with existing systems. Furthermore, code conversion prompts allow for customization of coding style, optimization level, and adherence to specific architectural patterns or design principles.

In some embodiments, a code conversion prompt describes instructions that is provided to a machine learning model for converting a decision tree to computer programmable code (e.g., computer programmable code 700). In some embodiments, the code conversion prompt comprises a reference to the decision tree and contextual data for the computer programmable code. In some embodiments, contextual data is used to enrich the code conversion prompt. For example, contextual data may comprise (i) one or more code samples, (ii) one or more syntax libraries, and/or (iii) one or more code commands. Contextual data may be provided to a machine learning model via a RAG architecture (e.g., RAG architecture 608).

Contextual data may play a crucial role in enhancing the performance and specificity of machine learning models in code generation and decision tree conversion tasks. Contextual data may provide supplemental input that guides a machine learning model's output to ensure that computer programmable code or decision structures generated by the machine learning model align with specific requirements, coding standards, or domain-specific practices.

The implementation of contextual data in a machine learning model pipeline may comprise retrieval and integration mechanisms. In a RAG architecture, for instance, relevant contextual information may be dynamically fetched from repository data (e.g., repository data 606) based on a current input or generation task. This retrieval process may utilize techniques, such as semantic search, embedding-based similarity matching, or more traditional information retrieval methods. Once retrieved, the contextual data may be encoded and concatenated with a primary input (e.g., decision tree) in a format that the machine learning model may process. Providing the contextual data in a form that is suitable for processing by the machine learning model may comprise techniques, such as special token delimitation, positional encoding, or the use of separate encoder stacks for different types of inputs.

Functionally, contextual data may serve to constrain and guide a machine learning model's output generation process, ensuring that output (e.g., computer programmable code) generated by the machine learning model adheres to specific syntactic structures, incorporates relevant library functions or API calls, and follows prescribed coding patterns or architectural designs. This approach significantly enhances the relevance and usability of the generated code or decision structures within specific development environments or application domains.

Returning to FIG. 4, in some embodiments, the process 400 comprises, at operation 408, transmitting the computer programmable code and instructions to install the computer programmable code on one or more computing devices to add or improve current functionality of a computer, such as automating a task for the prediction domain based on the text-based file. For example, the computing system 101 may transmit the computer programmable code and instructions to install the computer programmable code on one or more computing devices to add or improve current functionality of a computer, such as automating a task for the prediction domain based on the text-based file. According to various embodiments, the computer programmable code may also provide operational efficiency by streamlining data processing workflows, reduce errors by minimizing error-prone data entry processes, and provide predictive machine learning models or artificial intelligence functionality that may be continuously updated (e.g., via feedback) to improve prediction accuracy.

An automated task in the prediction domains may include the initiation of automated instructions across and between devices, automated notifications, automated scheduling operations, automated precautionary actions, automated security actions, automated data processing actions, automated data compliance actions, automated data access enforcement actions, automated adjustments to computing and/or human data access management, and/or the like.

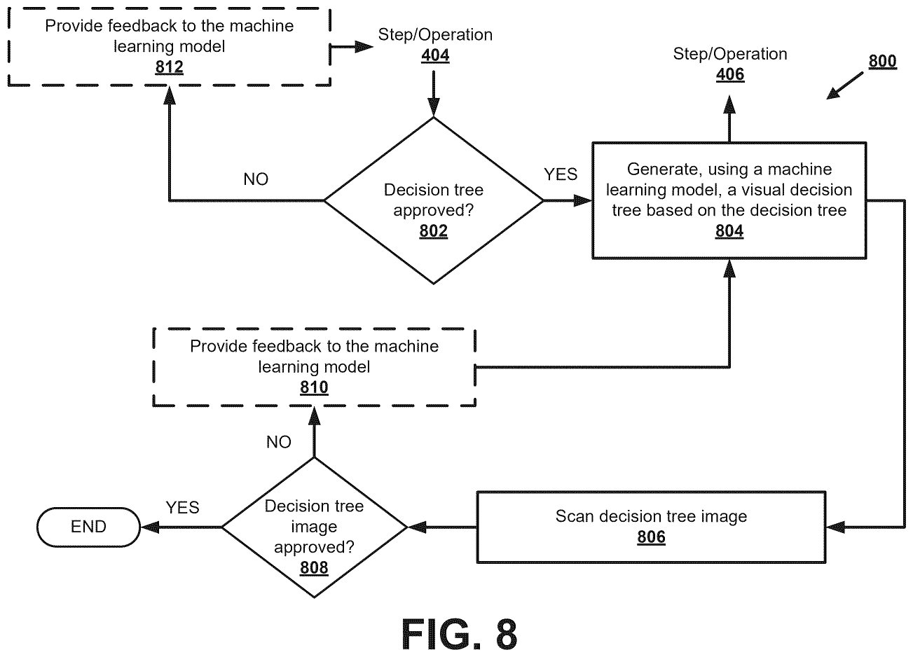

FIG. 8 depicts a flowchart diagram of an example decision tree review process 800 in accordance with some embodiments of the present disclosure. The flowchart diagram depicts an analysis of a decision tree generated from a text-based file to improve text-to-code conversion accuracy. The process 800 may be implemented by one or more computing devices, entities, and/or systems described herein. For example, via the various steps/operations of the process 800, the computing system 101 may generate and/or use a decision tree validation prompt to assess how well a machine learning model is able to generate a decision tree based on a text-based file. By doing so, the process 800 improves computer functionality by improving the interpretability and hallucination control of output generated by a machine learning model for verification and/or validation of text-to-code conversions.

FIG. 8 illustrates an example process 800 for explanatory purposes. Although the example process 800 depicts a particular sequence of steps/operations, the sequence may be altered without departing from the scope of the present disclosure. For example, some of the steps/operations depicted may be performed in parallel or in a different sequence that does not materially impact the function of the process 800. In other examples, different components of an example device or system that implements the process 800 may perform functions at substantially the same time or in a specific sequence.

In some embodiments, the process 800 comprises, at operation 802, determining an approval of a decision tree. For example, the computing system 101 may determine an approval of a decision tree that is generated by operation 404 of FIG. 4. As disclosed herewith, a decision tree may provide a format that may be more easily analyzed (e.g., than computer programmable code) to determine a machine learning model's performance with respect to correctly extracting and capturing features from a text-based file. As such, a decision tree may improve the interpretability of a machine learning model and facilitate correct and/or accurate outputs generated by the machine learning model. Accordingly, a decision tree may comprise an intermediary format that provides for more accurate conversion of a text-based file into computer programmable code.

In some embodiments, determining the approval of the decision tree comprises (i) receiving a decision tree validation response indicating a deviation between the decision tree and the set of standards and (ii) re-generating the decision tree based on using at least a portion of the decision tree validation response as input. In some embodiments, determining an approval of a decision tree comprises scanning the decision tree and determining the approval based on results of the scan of the decision tree. In some embodiments, the analysis comprises a machine-based analysis that uses a machine learning model to determine whether the decision tree comprises elements that are consistent with a text-based file from which the decision tree was generated based on. In some embodiments, using a machine learning model, a decision tree validation response is generated for a decision tree based on a decision tree validation prompt.

In some embodiments, a decision tree validation prompt refers to instructions that are provided to a machine learning model for validating an output decision tree (e.g., generated by a machine learning model in operation 404). In some embodiments, the decision tree validation prompt is automatically generated by a computing entity coupled to a machine learning model or by the machine learning model itself to assess how well the machine learning model is able to generate a decision tree based on a text-based file. For example, subsequent to generating an output decision tree based on a text-based file, a machine learning model may determine how well the output decision tree represents the text-based file with respect to accuracy and/or completeness.

In some embodiments, a validation machine learning model (e.g., other than a primary machine learning model) may be configured to evaluate an output decision tree generated by a primary machine learning model. In some embodiments, the validation machine learning model comprises a large language model that is configured and/or trained to assess the accuracy of an output decision tree generated by the primary machine learning model. In some embodiments, the validation machine learning model may comprise an independent machine learning model that is trained on a similar dataset as used to train the primary machine learning model. In some embodiments, the validation machine learning model may be configured to generate a validation decision tree based on a same text-based file provided to the primary machine learning model that is used to generate the output decision tree. As such, the validation decision tree may be compared with the output decision tree to determine any discrepancies that may be used to identify areas where the primary machine learning model performs in an unsatisfactory manner (e.g., inaccurate).

In some other embodiments, a decision tree validation prompt may be manually generated and provided to a machine learning model. In some embodiments, the decision tree is reviewed via a human-in-the-loop process.

In some embodiments, the process 800 comprises, optional operation 812, if the decision tree is not approved, providing feedback to a machine learning model that generated the decision tree based on the decision tree being not approved. For example, the computing system 101 provides a validation response as feedback to a machine learning model that generated the decision tree to re-generate the decision tree at operation 404 of FIG. 4 if the decision tree is not approved. In some embodiments, a decision tree validation response may be received at operation 802 indicating a deviation between the decision tree and the set of standards. In some embodiments, the feedback may comprise a degree and/or number of inaccuracies of the decision tree with respect to a text-based file. The feedback may also comprise an enumeration and/or specific details of inaccuracies (type of inaccuracy, such as spelling/grammar, associations, logic, etc.).

In some embodiments, the process 800 comprises, subsequent to optional operation 812, via operation 404 of FIG. 4, re-generating, using a machine learning model, the decision tree based on the text-based file, a decisioning prompt for the text-based file, and the feedback. For example, the computing system 101 may re-generate, using a machine learning model, a decision tree based on the text-based file, a decisioning prompt for the text-based file, and the feedback. In some embodiments, the decision tree is re-generated based on using at least a portion of a decision tree validation response as input. In some embodiments, the decision tree may be re-generated for the text-based file based on a decisioning prompt comprising the feedback from operation 812. In some embodiments, the decisioning prompt may comprise a negative example, such as a previously generated decision tree that comprises indications of inaccuracies, and/or a positive example, such as a corrected version of a previously generated decision tree. Alternatively or additionally, the feedback from operation 812 may be used to fine-tune or retrain the machine learning model.

In some embodiments, the process 800 comprises, subsequent to operation 802, if the decision tree is approved, at operation 804, generating, using a machine learning model, a visual decision tree based on the decision tree. For example, the computing system 101 may generate, using a machine learning model, a decision tree image based on the decision tree. In some embodiments, the decision tree image may be generated, using the machine learning model, based on a visual decisioning prompt. In some embodiments, a visual decisioning prompt describes instructions that are provided to a machine learning model for processing, extracting, parsing, and/or converting a text-based decision tree to a decision tree image. In some embodiments, a visual decisioning prompt comprises a reference to the decision tree and a decision tree image format (e.g., PNG, GIF, JPEG, TIFF, PDF, EPS, RAW, etc.). In some embodiments, a visual decisioning prompt comprises examples (e.g., few shot prompts) of decisions tree images to guide a machine learning model on the format and content of the decision tree image.

In some embodiments, the decision tree image may comprise an image rendering of the decision tree generated at operation 404. As disclosed herein, a decision tree may comprise text data that is formatted in a structured format that is suitable for input into a machine learning model. In some embodiments, the machine learning model used to generate the visual decision tree (e.g., decision tree image) comprises a text-to-image model. For example, the machine learning model may be configured to receive decision trees in the form of input text and generate a decision tree image corresponding to the input text. In some embodiments, the machine learning model is trained on decision tree images and their corresponding decision trees (e.g., structured text).

The decision tree image generated using the machine learning model may provide an additional validation that is performed on the decision tree to determine the decision tree comprises elements that are consistent with a text-based file from which the decision tree was generated based on. In some embodiments, generating the decision tree image comprises rendering text and associations from the decision tree as an image.

In some embodiments, the process 800 comprises, at operation 806, scanning the decision tree image. For example, the computing system 101 may scan the decision tree image. In some embodiments, scanning of the decision tree image comprises machine-based image data processing (e.g., computer vision) that uses a machine learning model to determine whether the decision tree image comprises elements that are consistent with the decision tree. In some embodiments, scanning the decision tree image comprises extracting image elements (e.g., using object classification, optical character recognition (OCR), natural language processing (NLP), etc.) from a decision tree image.

In some embodiments, the process 800 comprises, at operation 808, determining an approval of the decision tree image. For example, the computing system 101 may determine an approval of the decision tree image. In some embodiments, the approval of the decision tree image is based on results of the scanning of the decision tree image (e.g., from operation 806) and reconciling image elements extracted from the decision tree image with the decision tree (from which the decision tree image was generated based on) and/or a text-based file associated with the decision tree. The approval of decision tree image may comprise an additional decision tree validation process that uses image-based techniques for determining a degree and/or number of inaccuracies of the decision tree with respect to a text-based file.

In some embodiments, a validation machine learning model may be configured to evaluate the decision tree image. In some embodiments, the validation machine learning model comprises a large language model that is configured and/or trained to assess the accuracy of the decision tree image with respect to the decision tree (from which the decision tree image was generated based on) and/or a text-based file associated with the decision tree. In some embodiments, the validation machine learning model may comprise an independent machine learning model that is trained on a similar dataset as used to train the primary machine learning model for generating the decision tree image. In some embodiments, the validation machine learning model may be configured to generate a validation decision tree image based on a same decision tree provided to the primary machine learning model that is used to generate the decision tree image. As such, the validation decision tree image may be compared with the decision tree image to determine any discrepancies that may be used to identify areas where the primary machine learning model performs in an unsatisfactory manner (e.g., inaccurate).

In some other embodiments, analysis of the decision tree image may comprise a human-in-the-loop process. In some embodiments, if the decision tree image is approved, the process 800 ends.

In some embodiments, the process 800 comprises, at optional operation 810, if the decision tree image is not approved, providing feedback to the machine learning model. For example, the computing system 101 may provide feedback to the machine learning model. In some embodiments, the feedback is provided to the machine learning model that generated the decision tree image to re-generate the decision tree image at operation 804 if the decision tree image is not approved. In some embodiments, the feedback may comprise a degree and/or number of inaccuracies of the decision tree image with respect to the decision tree (from which the decision tree image was generated based on) and/or a text-based file associated with the decision tree. The feedback may also comprise an enumeration and/or specific details of inaccuracies (type of inaccuracy, such as spelling/grammar, associations, logic, etc.).

In some embodiments, the process 800 comprises, subsequent to optional operation 810, at operation 804, re-generating, using the machine learning model, the decision tree image based on the decision tree and the feedback from operation 810. For example, the computing system 101 may re-generate, using the machine learning model, the decision tree image based on the decision tree and the feedback from operation 810. In some embodiments, the decision tree image may be re-generated based on a visual decisioning prompt comprising the feedback from operation 810. In some embodiments, the visual decisioning prompt may comprise a negative example, such as a previously generated decision tree image that comprises indications of inaccuracies, and/or a positive example, such as a corrected version of a previously generated decision tree image. Alternatively or additionally, the feedback from operation 810 may be used to fine-tune or retrain the machine learning model used to re-generate the decision tree image.

In some embodiments, the process 800 comprises, subsequent to operation 804, via operation 406 of FIG. 4, generating, using the machine learning model, computer programmable code for the visual decision tree based on the decision tree and a code conversion prompt for the visual decision tree.

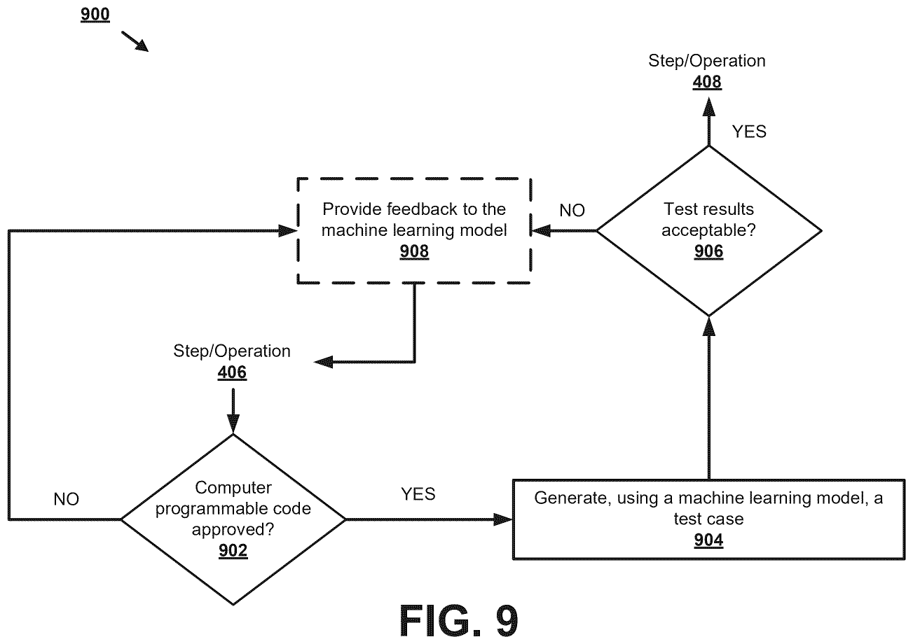

FIG. 9 depicts a flowchart diagram of an example computer programmable code testing process 900 in accordance with some embodiments of the present disclosure. The flowchart diagram depicts an analysis of computer programmable code generated from a decision tree to further improve text-to-code conversion accuracy. The process 900 may be implemented by one or more computing devices, entities, and/or systems described herein. For example, via the various steps/operations of the process 900, the computing system 101 may generate and/or use a code validation prompt to assess how well a machine learning model is able to generate a computer programmable code based on a decision tree. By doing so, the process 900 improves computer functionality by improving accuracy and/or completeness of output generated by a machine learning model for verification and/or validation of text-to-code conversions.

FIG. 900 illustrates an example process 900 for explanatory purposes. Although the example process 900 depicts a particular sequence of steps/operations, the sequence may be altered without departing from the scope of the present disclosure. For example, some of the steps/operations depicted may be performed in parallel or in a different sequence that does not materially impact the function of the process 900. In other examples, different components of an example device or system that implements the process 900 may perform functions at substantially the same time or in a specific sequence.

In some embodiments, the process 900 comprises, at operation 902, determining an approval of computer programmable code. For example, the computing system 101 may determine an approval of computer programmable code that is generated by operation 406 of FIG. 4. In some embodiments, determining the approval of computer programmable code further comprises (i) receiving a code validation response and (ii) in response to the code validation response identifying a deviation between the decision tree and the computer programmable code, re-generating the computer programmable code. In some embodiments, determining the approval of the computer programmable code comprises analyzing the computer programmable code and determining the approval based on results of the analysis of the computer programmable code. In some embodiments, the analysis comprises a machine-based analysis that uses a machine learning model to determine whether the computer programmable code comprises elements that respectively correspond to a decision tree from which the computer programmable code was generated based on. In some embodiments, using a machine learning model, a code validation response is generated for computer programmable code based on a code validation prompt.

In some embodiments, a code validation prompt refers to instructions that are provided to a machine learning model for validating computer programmable code (e.g., generated by a machine learning model in operation 406). In some embodiments, the code validation prompt is automatically generated by a computing entity coupled to a machine learning model or by the machine learning model itself to assess how well the machine learning model is able generate computer programmable code based on a decision tree. For example, subsequent to generating computer programmable code based on a decision tree, machine learning model may determine how well the computer programable code set represents the decision tree with respect to accuracy and/or completeness. In some other embodiments, a code validation prompt may be manually generated and provided to a machine learning model. In some embodiments, the computer programmable code is reviewed via a human-in-the-loop process.

In some embodiments, the process 900 comprises, at optional operation 908, if the computer programmable code is not approved, providing feedback to a machine learning model that generated the computer programmable code. For example, the computing system 101 may provide feedback to a machine learning model that generated the computer programmable code based on the computer programmable code being not approved. In some embodiments, the feedback comprises a degree and/or number of inaccuracies of the computer programmable code with respect to the decision tree (from which the programmable code was generated based on) and/or a text-based file associated with the decision tree. The feedback may also comprise an enumeration and/or specific details of inaccuracies (type of inaccuracy, such as syntax, logic, semantic, function, etc.).

In some embodiments, the process 900 comprises, subsequent to optional operation 908, via operation 406 of FIG. 4, if the computer programmable code is not approved, re-generating (the computer programmable code based on the decision tree and a code conversion prompt for the decision tree. For example, the computing system 101 may re-generate the computer programmable code based on the decision tree and a code conversion prompt for the decision tree. In some embodiments, the computer programmable code may be re-generated based on a code conversion prompt comprising the feedback from operation 908. In some embodiments, the code conversion prompt may comprise a negative example, such as previously generated computer programmable code that comprises indications of inaccuracies, and/or a positive example, such as a corrected version of a previously generated computer programmable code. Alternatively or additionally, the feedback from operation 908 may be used to fine-tune or retrain the machine learning model used to re-generate the computer programmable code.

In some embodiments, the process 900 comprises, at operation 904, if the computer programmable code is approved, generating, using a machine learning model, a test case. For example, the computing system 101 may generate, using a machine learning model, a test case. In some embodiments, the test case is generated based on a test prompt that is provided to the machine learning model.

In some embodiments, a test prompt describes instructions that are provided to a machine learning model for testing functionality of computer programmable code. For example, a test prompt may direct a machine learning model to generate sample input and expected output. The sample input may be provided to computer programmable code for generating an output that may be compared with the sample input. In some embodiments, a test prompt comprises a reference to one or more inputs and respectively corresponding outputs based on a text-based file or a decision tree that is associated with computer programmable code to be tested.

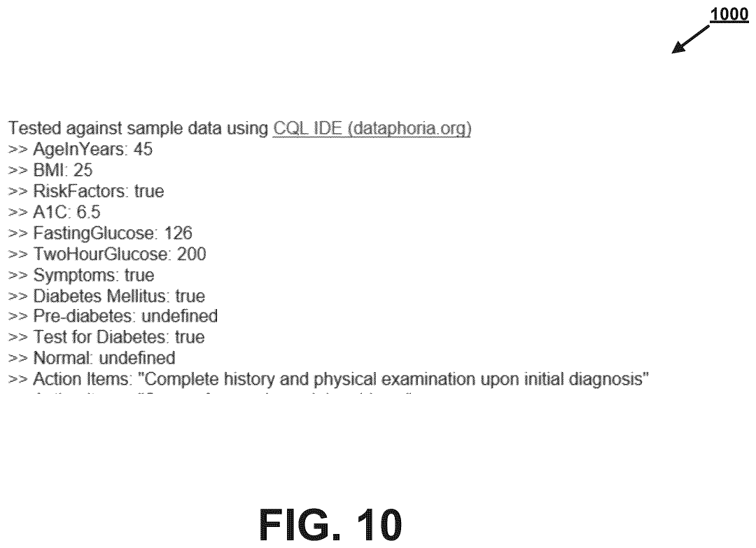

FIG. 10 depicts an operational example of a test case 1000 in accordance with some embodiments of the present disclosure.

In some embodiments, the test case 1000 describes sample input data and expected output data that are generated by using a machine learning model to confirm functionality (e.g., validate the comprehensiveness and correctness) of computer programmable code.

In some embodiments, the test case 1000 comprises synthetic data that is generated based on a text-based file by using a machine learning model. For example, a machine learning model may be used to generate synthetic data based on repository data (e.g., repository data 606) and/or historical text-based files, where a test case, such as test case 1000, may be generated, using the machine learning model, based on the synthetic data.

Test cases may represent a critical component in validation and quality assurance process for automatically generated code. In some examples, test cases may be designed to exercise various paths and conditions within computer programmable code, ensuring that the computer programmable code correctly implements logic specified in an original text-based file.

The implementation of test case generation using a machine learning model may comprise natural language understanding and code analysis techniques. For example, a machine learning model may be trained to interpret text-based files and the structure of computer programmable code to be tested such that key decision points, edge cases, and potential failure modes may be identified. As such, the machine learning model may generate a set of input data designed to traverse different execution paths within computer programmable code. Additionally, a machine learning model may incorporate domain-specific knowledge to generate realistic and meaningful test data that reflects typical use cases or scenarios relevant to the application domain. A test case generation process may also comprise techniques, such as symbolic execution or constraint solving to ensure comprehensive coverage of computer programmable code's logic.

As disclosed herewith, test cases may serve multiple purposes. For example, test cases may provide a validation mechanism for computer programmable code, allowing for rapid identification of any discrepancies between intended logic and its implementation. This is particularly valuable in the context of automated code generation, where ensuring the correctness of the output is paramount.

Moreover, test cases may be integrated into continuous integration and deployment pipelines, enabling ongoing validation of computer programmable code as it evolves or as the underlying text-based file is updated. Such integration may help maintain the reliability and correctness of a system over time.

Alternative applications of the aforementioned test case generation capability may comprise using it to create documentation or usage examples for computer programmable code, or to generate benchmark datasets for evaluating different implementations or optimizations of a same decisioning logic.

Returning to FIG. 9, in some embodiments, the process 900 comprises, at operation 906, determining whether applying the test case on the computer programmable code generates acceptable test results. For example, the computing system 101 may determine whether applying the test case on the computer programmable code generates acceptable test results.

In some embodiments, acceptability of test results generated by computer programmable code using a test case is determined by comparing the test results to expected output data of the test case. In some embodiments, applying the test case on the computer programmable code comprises executing the computer programmable code in accordance with the test case to generate a test result. In some embodiments, applying the test case on the computer programmable code further comprises generating synthetic data. In some embodiments, synthetic data comprises artificial data that may be generated to replicate features of actual data. For example, synthetic data may comprise a variety of test data (e.g., that cause positive results and/or negative results) that may be provided to test the functionality of the computer programmable code without access to or availability of actual data.

In some embodiments, applying a test case on the computer programmable code comprises (i) generating, using a machine learning model, a target synthetic population based on a set of standards for a prediction domain and (ii) generating, using the machine learning model, a population query for the target synthetic population. The target synthetic population may comprise an example data cohort that may be provided to the computer programmable code to establish a basis for generating one or more test results responsive to a test case comprising the population query. For example, the population query may comprise a command or request that is provided to the computer programmable code for performing one or more data operations on the target synthetic population to generate a data output. Accordingly, via the execution of the computer programmable code with the test case, data output may be generated by the computer programmable code. The data output may comprise a test result that is compared with one or more testing criteria. For example, the one or more testing criteria may be associated with correct functionality of the computer programmable code with respect to an underlying text-based file the computer programmable code was generated based on. In some embodiments, responsive to the test results satisfying the one or more testing criteria (e.g., representative of the computer programable code comprising a desired level of correct functionality), the computer programmable code is stored in a code repository.

In some embodiments, the process 900 comprises, subsequent to operation 906, via operation 408 of FIG. 4, if the test results are approved, transmitting the computer programmable code and instructions to install the computer programmable code on one or more computing devices to add or improve current functionality of a computer, such as automating a task for the prediction domain based on the text-based file. For example, the computing system 101 may transmit the computer programmable code and instructions to install the computer programmable code on one or more computing devices to add or improve current functionality of a computer, such as automating a task for the prediction domain based on the text-based file. According to various embodiments, the computer programmable code may also provide operational efficiency by streamlining data processing workflows, reduce errors by minimizing error-prone data entry processes, and provide predictive machine learning models or artificial intelligence functionality that may be continuously updated (e.g., via feedback) to improve prediction accuracy.

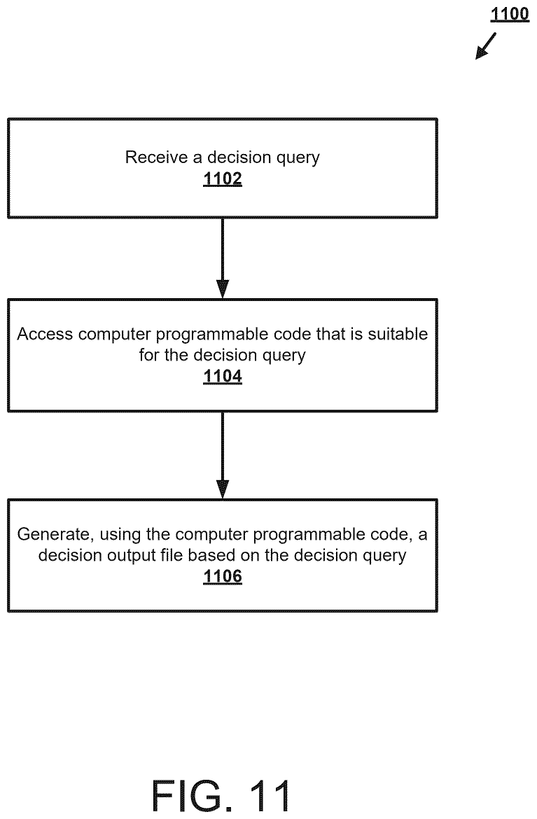

FIG. 11 depicts a flowchart diagram of an example decision process 1100 in accordance with some embodiments of the present disclosure. The flowchart diagram depicts using computer programmable code to generate decisioning output within an example environment. The process 1100 may be implemented by one or more computing devices, entities, and/or systems described herein. For example, via the various steps/operations of the process 1100, the computing system 101 may generate an output file and/or use computer programmable code to recommend and/or perform prediction-based actions based on a decision query. By doing so, the process 1100 improves computer functionality by providing actionable outputs based on decisions generated by computer programmable code.

FIG. 11 illustrates an example process 1100 for explanatory purposes. Although the example process 1100 depicts a particular sequence of steps/operations, the sequence may be altered without departing from the scope of the present disclosure. For example, some of the steps/operations depicted may be performed in parallel or in a different sequence that does not materially impact the function of the process 1100. In other examples, different components of an example device or system that implements the process 1100 may perform functions at substantially the same time or in a specific sequence.

In some embodiments, the process 1100 comprises, at operation 1102, receiving a decision query. For example, the computing system 101 may receive a decision query. In some embodiments, a decision query comprises data of a patient (e.g., electronic medical record (EMR) and/or electronic health record (EHR)) and a decision objective. A decision objective may comprise a desired outcome to be achieved by performing a sequence of one or more actions associated with respectively corresponding one or more decisions.

In some embodiments, the process 1100 comprises, at operation 1104, accessing computer programmable code that is suitable for the decision query. For example, the computing system 101 may access computer programmable code that is suitable for the decision query. In some embodiments, accessing the computer programmable code further comprises (i) comparing the decision query with input data and/or output data of a plurality of computer programmable codes, (ii) determining a similarity measure between the decision query and the input data and/or output data for each of the plurality of computer programmable codes, and (iii) matching/determining a computer programmable code from the plurality of computer programmable code based on the similarity measure.

In some embodiments, the computer programmable code comprises a machine learning model that is trained to generate prediction outputs based on computer programmable code that is associated with the decision objective. In some embodiments, the computer programmable code is generated based on a decision tree that is associated (e.g., generated based on) with a text-based file, as described herewith.

In some embodiments, the process 1100 comprises, at operation 1106, generating, using the computer programmable code, a decision output file based on the decision query. For example, the computing system 101 may generate, using the computer programmable code, a decision output file based on the decision query. For example, the decision output file may comprise a transcript (e.g., text) that may aid (e.g., healthcare support decision) a healthcare provider at a point of care by providing treatment and/or care recommendations (and/or facilitation thereof via automation), alerts, allocation of resources, etc., for achieving a desired health outcome.

Some techniques of the present disclosure enable the generation of action outputs that may be performed to initiate one or more real world actions to achieve real-world effects. The techniques of the present disclosure may be used, applied, and/or otherwise leveraged to generate a prediction based on provided input data and displaying the prediction on a user interface. In some examples, computer programmable code may trigger action outputs (e.g., through control instructions) to automate generating a diagnostic report, displaying/providing resources, generating, executing action scripts, and/or the like. The action outputs may control various aspects of a client device, such as the display, transmission, and/or the like of data reflective of an alert, and/or the like. The alert may be automatically communicated to a user and/or may be used to initiate a security protocol (e.g., locking a computer), a robotic action (e.g., performing an automated screening process), and/or the like.

In some examples, the computing tasks may comprise actions that may be based on a particular domain. A domain may comprise any environment in which computing systems may be applied to interpret, store, and process data and initiate the performance of computing tasks responsive to the data. These actions may cause real-world changes, for example, by controlling a hardware component, providing alerts, interactive actions, and/or the like. For instance, actions may comprise the initiation of automated instructions across and between devices, automated notifications, automated scheduling operations, automated precautionary actions, automated security actions, automated data processing actions, and/or the like.

### IV. Conclusion

Throughout this specification, components, operations, or structures described as a single instance may be implemented as multiple instances. Although individual operations of one or more methods (or processes, techniques, routines, etc.) are illustrated and described as separate operations, two or more of the individual operations may be performed concurrently or otherwise in parallel, and nothing requires that the operations be performed in the order illustrated. Structures and functionality (e.g., operations, steps, blocks) presented as separate components in example configurations may be implemented as a combined structure, functionality, or component. Similarly, structures and functionality presented as a single component may be implemented as separate components. These and other variations, modifications, additions, and improvements fall within the scope of the subject matter herein.

Certain embodiments are described herein as including logic or a number of routines, subroutines, applications, operations, blocks, or instructions. These may constitute and/or be implemented by software (e.g., code embodied on a non-transitory, machine-readable medium), hardware, or a combination thereof. In hardware, the routines, etc., may represent tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware component that operates to perform certain operations as described herein.

In various embodiments, a hardware component may be implemented mechanically or electronically. For example, a hardware component may comprise dedicated circuitry or logic that is permanently configured (e.g., as a special-purpose processor, such as a field programmable gate array (FPGA) or an application-specific integrated circuit (ASIC)) to perform certain operations. A hardware component may also or instead comprise programmable logic or circuitry (e.g., as encompassed within one or more general-purpose processors and/or other programmable processor(s)) that is temporarily configured by software to perform certain operations.

Accordingly, the term “hardware component” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where the hardware components comprise a general-purpose processor configured using software, the general-purpose processor may be configured as respective different hardware components at different times. Software may accordingly configure a processor, for example, to constitute a particular hardware component at one instance of time and to constitute a different hardware component at a different instance of time.

Hardware components may provide information to, and receive information from, other hardware components. Accordingly, the described hardware components may be regarded as being communicatively coupled. Where multiple of such hardware components exist contemporaneously, communications may be achieved through signal transmission (e.g., over appropriate circuits and buses) that connect the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and may operate on a resource (e.g., a collection of information).

As noted above, the various operations of example methods (or processes, techniques, routines, etc.) described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions. The components referred to herein may comprise processor-implemented components.

Moreover, each operation of processes illustrated as logical flow graphs may represent a sequence of operations that may be implemented in hardware, software, or a combination thereof. In the context of software, the operations represent computer-executable instructions stored on one or more computer-readable storage media that, when executed by one or more processors, perform the recited operations. Generally, computer-executable instructions comprise routines, programs, objects, components, data structures, and the like that perform particular functions or implement particular data types. The order in which the operations are described is not intended to be construed as a limitation, and any number of the described operations may be combined in any order and/or in parallel to implement the processes.

The terms “coupled” and “connected,” along with their derivatives, may be used. In particular embodiments, “connected” may be used to indicate that two or more elements are in direct physical or electrical contact with each other, although the context in the description may dictate otherwise when it is apparent that two or more elements are not in direct physical or electrical contact. “Coupled” may mean that two or more elements are in direct physical or electrical contact. However, “coupled” may also mean that two or more elements are not in direct contact with each other, yet still co-operate, transmit between, or interact with each other.

An algorithm may be considered to be a self-consistent sequence of acts or operations leading to a desired result. These comprise physical manipulations of physical quantities. Usually, though not necessarily, these quantities take the form of electrical, magnetic, or optical signals capable of being stored, transferred, combined, compared, and otherwise manipulated. These signals are commonly referred to as bits, values, elements, symbols, characters, terms, numbers, flags, or the like. It should be understood, however, that all of these and similar terms are to be associated with the appropriate physical quantities and are merely convenient labels applied to these quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “some embodiments,” “one embodiment,” “an embodiment,” “in some examples,” or variations thereof means that a particular element, feature, structure, characteristic, operation, or the like described in connection with the embodiment is included in at least one embodiment, but not every embodiment necessarily comprises the particular element, feature, structure, characteristic, operation, or the like. Different instances of such a reference in various places in the specification do not necessarily all refer to the same embodiment, although they may in some cases. Moreover, different instances of such a reference may describe elements, features, structures, characteristics, operations, or the like be combined in any manner as an embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may comprise other elements not expressly listed or inherent to such process, method, article, or apparatus. Further, unless the context of use clearly indicates otherwise, “or” refers to an inclusive or and not to an exclusive or. For example, a condition A or B is satisfied by any one of the following: A is true (or present) and B is false (or not present), A is false (or not present) and B is true (or present), and both A and B are true (or present).

The term “set” is intended to mean a collection of elements and may be a null set (i.e., a set containing zero elements) or may comprise one, two, or more elements. A “subset” is intended to mean a collection of elements that are all elements of a set, but that does not comprise other elements of the set. A first subset of a set may comprise zero, one, or more elements that are also elements of a second subset of the set. The first subset may be said to be a subset of the second subset if all the elements of the first subset are elements of the second subset, while also being a subset of the set. However, if all the elements of the second subset are also elements of the first subset (in addition to all the elements of the first subset being elements of the second subset), the first subset and the second subset are a single subset/not distinct.

For the purposes of the present disclosure, the term “a” or “an” entity refers to one or more of that entity. As such, the terms “a” or “an”, “one or more”, and “at least one” may be used interchangeably herein unless explicitly contradicted by the specification using the word “only one” or similar. For example, “a first element” may functionally be interpreted as “a first one or more elements” or a “first at least one element.” Unless otherwise apparent from the context of use, reference in the present disclosure to a same set of “one or more processors” (or a same “plurality of processors,” etc.) performing multiple operations may encompass implementations in which performance of the operations is divided among the processor(s) in any suitable way. For example, “generating, by one or more processors, X; and generating, by the one or more processors, Y” may encompass: (1) implementations in which a first subset of the processors (e.g., in a first computing device) generates X and an entirely distinct, second subset of the processors (e.g., in a different, second computing device) independently generates Y; (2) implementations in which one or more or all of the processor(s) (e.g., one or multiple processors in the same device, or multiple processors distributed among multiple devices) contribute to the generation of X and/or Y; and (3) other variations. This may similarly be applied to any other component or feature similarly recited (e.g., as “a component”, “a feature”, “one or more components”, “one or more features”, “a plurality of components”, “a plurality of features”). Moreover, the performance of certain of the operations may be distributed among the one or more components, not only residing within a single machine, but deployed across a number of machines. The set of components may be located in a single geographic location (e.g., within a home environment, an office environment, a cloud environment). In other example embodiments, the set of components may be distributed across two or more geographic locations. Further, “a machine learning model”, equivalent terms (e.g., “machine learning model,” “machine-learning model,” “machine-learned component”, “artificial intelligence”, “artificial intelligence component”), or species thereof (e.g., “a large language model”, “a neural network”) may comprise a single machine learning model or multiple machine learning models, such as a pipeline comprising two or more machine learning models arranged in series and/or parallel, an agentic framework of machine learning models, or the like.

An “artificial intelligence” or “artificial intelligence component” may comprise a machine learning model. A machine learning model may comprise a hardware and/or software architecture having structural hyperparameters defining the model's architecture and/or one or more parameters (e.g., coefficient(s), weight(s), biase(s), activation function(s) and/or action function type(s) in examples where the activation function and/or function type is determined as part of training, clustering centroid(s)/medoid(s), partition(s), number of trees, tree depth, split parameters) determined as a result of training the machine learning model based on training hyperparameters (e.g., for supervised, semi-supervised, and reinforcement learning models) and/or by iteratively operating the machine learning model according to the training hyperparameters(e.g., for unsupervised machine learning models).

In some examples, structural hyperparameter(s) may define component(s) of the model's architecture and/or their configuration/order, such as, for example, the configuration/order specifying which input(s) are provided to one component and which output(s) of that component are provided as input to other component(s) of the machine learning model; a number, type, and/or configuration of component(s) per layer; a number of layers of the model; a number and/or type of input nodes in an input layer of the model; a number and/or type of nodes in a layer; a number and/or type of output nodes of an output layer of the model; component dimension (e.g., input size versus output size); a number of trees; a maximum tree depth; node split parameters; minimum number of samples in a leaf node of a tree; and/or the like. The component(s) of the model may comprise one or more activation functions and/or activation function type(s) (e.g., gated linear unit (GLU), such as a rectified linear unit (ReLU), leaky RELU, Gaussian error linear unit (GELU), Swish, hyperbolic tangent), one or more attention mechanism and/or attention mechanism types (e.g., self-attention, cross-attention), nodes and split indications and/or probabilities in a decision tree, and/or various other component(s) (e.g., adding and/or normalization layer, pooling layer, filter). Various combinations of any these components (as defined by the structural hyperparameter(s)) may result in different types of model architectures, such as a transformer-based machine learning model (e.g., encoder-only model(s), encoder-decoder model(s), decoder-only models, generative pre-trained transformer(s) (GPT(s))), neural network(s), multi-layer perceptron(s), Kolmogorov-Arnold network(s), clustering algorithm(s), support vector machine(s), gradient boosting machine(s), and/or the like. The structural parameters and components a machine learning model comprises may vary depending on the type of machine learning model.

Training hyperparameter(s) may be used as part of training or otherwise determining the machine learning model. In some examples, the training hyperparameter(s), in addition to the training data and/or input data, may affect determining the parameter(s) of the machine learning model. Using a different set of training hyperparameters to train two machine learning models that have the same architecture (i.e., the same structural hyperparameters) and using the same training data may result in the parameters of the first machine learning model differing from the parameters of the second machine learning model. Despite having the same architecture and having been trained using the same training data, such machine learning models may generate different outputs from each other, given the same input data. Accordingly, accuracy, precision, recall, and/or bias may vary between such machine learning models.

In some examples, training hyperparameter(s) may comprise a train-test split ratio, activation function and/or activation function type (e.g., in examples like Kolmogorov-Arnold networks (KANs) where the activation function type is determined as part of training from an available set of activation functions and/or limits on the activation function parameters specified by the training hyperparameters), training stage(s) (e.g., using a first set of hyperparameters for a first epoch of training, a second set of hyperparameters for a second epoch of training), a batch size and/or number of batches of data in a training epoch, a number of epochs of training, the loss function used (e.g., L1, L2, Huber, Cauchy, cross entropy), the component(s) of the machine learning model that are altered using the loss for a particular batch or during a particular epoch of training (e.g., some components may be “frozen,” meaning their parameters are not altered based on the loss), learning rate, learning rate optimization algorithm type (e.g., gradient descent, adaptive, stochastic) used to determine an alteration to one or more parameters of one or more components of the machine learning model to reduce the loss determined by the loss function, learning rate scheduling, and/or the like.

In some examples, the structural hyperparameters and/or the training hyperparameters may be determined by a hyperparameter optimization algorithm or based on user input, such as a software component written by a user or generated by a machine learning model. The machine learning model may comprise any type of model configured, trained, and/or the like to generate a prediction output for a model input. In some examples, any of the logic, component(s), routines, and/or the like discussed herein may be implemented as a machine learning model.

The machine learning model may comprise one or more of any type of machine learning model including one or more supervised, unsupervised, semi-supervised, and/or reinforcement learning models. Training a machine learning model may comprise altering one or more parameters of the machine learning model (e.g., using a loss optimization algorithm) to reduce a loss. Depending on whether the machine learning model is supervised, semi-supervised, unsupervised, etc. this loss may be determined based on a difference between an output generated by the model and ground truth data (e.g., a label, an indication of an outcome that resulted from a system using the output), a cost function, a fit of the parameter(s) to a set of data, a fit of an output to a set of data, and/or the like. In some examples, determining an output by a machine learning model may comprise executing a set of inference operations executed by the machine learning model according to the machine learning model's parameter(s) and structural hyperparameter(s) and using/operating on a set of input data.

Moreover, any discussion of receiving data associated with an individual that may be protected, confidential, or otherwise sensitive information, is understood to have been preceded by transmitting a notice of use of the data to a computing device, account, or other identifier (collectively, “identifier”) associated with the individual, receiving an indication of authorization to use the data from the identifier, and/or providing a mechanism by which a user may cause use of the data to cease or a copy of the data to be provided to the user.

Upon reading this disclosure, those of skill in the art will appreciate still additional alternative structural and functional designs through the principles disclosed herein. Therefore, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The patent claims at the end of this patent application are not intended to be construed under 35 U.S.C. § 112(f) unless traditional means-plus-function language is expressly recited, such as “means for” or “step for” language being explicitly recited in the claim(s).

### V. Examples

Some embodiments of the present disclosure may be implemented by one or more computing devices, entities, and/or systems described herein to perform one or more example operations, such as those outlined below. The examples are provided for explanatory purposes. Although the examples outline a particular sequence of steps/operations, each sequence may be altered without departing from the scope of the present disclosure. For example, some of the steps/operations may be performed in parallel or in a different sequence that does not materially impact the function of the various examples. In other examples, different components of an example device or system that implements a particular example may perform functions at substantially the same time or in a specific sequence.

Moreover, although the examples may outline a system or computing entity with respect to one or more steps/operations, each operation may be performed by any one or combination of computing devices, entities, and/or systems described herein. For example, a computing system may comprise a single computing entity that is configured to perform all of the steps/operations of a particular example. In addition, or alternatively, a computing system may comprise multiple dedicated computing entities that are respectively configured to perform one or more of the steps/operations of a particular example. By way of example, the multiple dedicated computing entities may coordinate to perform all of the steps/operations of a particular example.
Example 1. A computer-implemented method comprising receiving, by one or more processors, a text-based file that defines a set of standards for a prediction domain; generating, by the one or more processors and using a machine learning model, a decision tree based on (i) the text-based file and (ii) a decisioning prompt for the text-based file; generating, by the one or more processors and using the machine learning model, computer programmable code for the set of standards based on the decision tree and a code conversion prompt for the decision tree; and transmitting, by the one or more processors, the computer programmable code and instructions to install the computer programmable code on one or more computing devices to automate a task for the prediction domain.
Example 2. The computer-implemented method of example 1, wherein the machine learning model comprises a pre-trained transformer-based machine learning model that is finetuned using a training dataset that comprises at least one of (i) a historical text-based file, (ii) a historical decision tree corresponding to the historical text-based file, or (iii) historical computer programmable code corresponding to the historical text-based file.
Example 3. The computer-implemented method of example 1, wherein the code conversion prompt comprises a reference to the decision tree and contextual data for the computer programmable code that identifies at least one of (i) a code sample, (ii) a syntax library, or (iii) a code command.
Example 4. The computer-implemented method of example 3 further comprising determining the contextual data by generating, using an encoder, a prompt embedding based on the code conversion prompt; accessing a plurality of contextual data embeddings that are associated with repository data; determining a distance between the prompt embedding and each of the plurality of contextual data embeddings; and identifying a subset of the plurality of contextual data embeddings that are most similar to the prompt embedding based on the distance.
Example 5. The computer-implemented method of example 1 further comprising generating, using the machine learning model, a test case for the computer programmable code; executing the computer programmable code in accordance with the test case to generate a test result; and responsive to the test result satisfying a testing criterion, transmitting the instructions to install the computer programmable code.
Example 6. The computer-implemented method of example 5, wherein generating the test case further comprises generating, using the machine learning model, a target synthetic population based on the set of standards; and generating, using the machine learning model, a population query for the target synthetic population.
Example 7. The computer-implemented method of example 1 further comprising receiving a decision tree validation response indicating a deviation between the decision tree and the set of standards; and re-generating the decision tree based on using at least a portion of the decision tree validation response as input.
Example 8. The computer-implemented method of example 1 further comprising detecting from a set of data sources that the text-based file has newly been added to or modified at one of the set of data sources; and receiving the text-based file based on identifying the text-based file as a new or modified text-based file.
Example 9. The computer-implemented method of example 1 further comprising receiving a code validation response; and in response to the code validation response identifying a deviation between the decision tree and the computer programmable code, re-generating the computer programmable code.
Example 10. A system comprising one or more processors; and at least one memory storing processor-executable instructions that, when executed by any one or more of the one or more processors, causes the one or more processors to perform operations comprising: receiving a text-based file that defines a set of standards for a prediction domain; generating, using a machine learning model, a decision tree based on (i) the text-based file and (ii) a decisioning prompt for the text-based file; generating, using the machine learning model, computer programmable code for the set of standards based on the decision tree and a code conversion prompt for the decision tree; and transmitting the computer programmable code and instructions to install the computer programmable code on one or more computing devices to automate a task for the prediction domain.
Example 11. The system of example 10, wherein the machine learning model comprises a pre-trained transformer-based machine learning model that is finetuned using a training dataset that comprises at least one of: (i) a historical text-based file, (ii) a historical decision tree corresponding to the historical text-based file, or (iii) historical computer programmable code corresponding to the historical text-based file.
Example 12. The system of example 10, wherein the code conversion prompt comprises a reference to the decision tree and contextual data for the computer programmable code that identifies at least one of (i) a code sample, (ii) a syntax library, or (iii) a code commands.
Example 13. The system of example 10, wherein the operations further comprise generating, using the machine learning model, a test case for the computer programmable code; executing the computer programmable code in accordance with the test case to generate a test result; and responsive to the test result satisfying a testing criterion, transmitting the instructions to install the computer programmable code.
Example 14. The system of example 13, wherein generating the test case comprises: generating, using the machine learning model, a target synthetic population based on the set of standards; and generating, using the machine learning model, a population query for the target synthetic population.
Example 15. The system of example 10, wherein the operations further comprise receiving a decision tree validation response indicating a deviation between the decision tree and the set of standards; and re-generating the decision tree based on using at least a portion of the decision tree validation response as input.
Example 16. The system of example 10, wherein the operations further comprise detecting from a set of data sources that the text-based file has newly been added to or modified at one of the set of data sources; and receiving the text-based file based on identifying the text-based file as a new or modified text-based file.
Example 17. The system of example 10, wherein the operations further comprise receiving a code validation response; and in response to the code validation response identifying a deviation between the decision tree and the computer programmable code, re-generating the computer programmable code.
Example 18. One or more non-transitory computer-readable storage media including instructions that, when executed by one or more processors, cause the one or more processors to perform operations comprising receiving a text-based file that defines a set of standards for a prediction domain; generating, using a machine learning model, a decision tree based on (i) the text-based file and (ii) a decisioning prompt for the text-based file; generating, using the machine learning model, computer programmable code for the set of standards based on the decision tree and a code conversion prompt for the decision tree; and transmitting the computer programmable code and instructions to install the computer programmable code on one or more computing devices to automate a task for the prediction domain.
Example 19. The one or more non-transitory computer-readable storage media of example 18, wherein the code conversion prompt comprises a reference to the decision tree and contextual data for the computer programmable code that identifies at least one of (i) a code sample, (ii) a syntax library, or (iii) a code commands.
Example 20. The one or more non-transitory computer-readable storage media of example 18, wherein the operations further comprise: generating, using the machine learning model, a test case for the computer programmable code; executing the computer programmable code in accordance with the test case to generate a test result; and responsive to the test result satisfying a testing criterion, transmitting the instructions to install the computer programmable code.
Example 21. The computer-implemented method of example 1 further comprising training the machine learning model.
Example 22. The computer-implemented method of example 21, wherein the training is performed by the one or more processors.
Example 23. The computer-implemented method of example 21, wherein the one or more processors are included in a first computing entity; and the training is performed by one or more other processors included in a second computing entity.
Example 24. The computing system of example 10, wherein the operations further comprise training the machine learning model.
Example 25. The computing system of example 24, wherein the one or more processors are included in a first computing entity; and the machine learning model is trained by one or more other processors included in a second computing entity.
Example 26. The one or more non-transitory computer-readable storage media of example 18, wherein the operations further comprise training the machine learning model.
Example 27. The one or more non-transitory computer-readable storage media of example 26, wherein the one or more processors are included in a first computing entity; and the machine learning model is trained by one or more other processors included in a second computing entity.
Example 28. A computer-implemented method comprising receiving, by one or more processors, a decision query that comprises patient data; accessing, by the one or more processors, computer programmable code that is suitable for the decision query; and generating, by the one or more processors and using the computer programmable code, a decision output file that is associated with providing a healthcare support decision based on the decision query.
Example 29. The computer-implemented method of example 28, wherein the computer programmable code is generated by a machine learning model based on a decision tree and a code conversion prompt for the decision tree, and wherein the decision tree is generated based on (i) a text-based file that defines a set of standards for a prediction domain and (ii) a decisioning prompt for the text-based file.

1. A computer-implemented method comprising:
receiving, by one or more processors, a text-based file that defines a set of standards for a prediction domain;
generating, by the one or more processors and using a machine learning model, a decision tree based on (i) the text-based file and (ii) a decisioning prompt for the text-based file;
generating, by the one or more processors and using the machine learning model, computer programmable code for the set of standards based on the decision tree and a code conversion prompt for the decision tree; and
transmitting, by the one or more processors, the computer programmable code and instructions to install the computer programmable code on one or more computing devices to automate a task for the prediction domain.

2. The computer-implemented method of claim 1, wherein the machine learning model comprises a pre-trained transformer-based machine learning model that is finetuned using a training dataset that comprises at least one of (i) a historical text-based file, (ii) a historical decision tree corresponding to the historical text-based file, or (iii) historical computer programmable code corresponding to the historical text-based file.

3. The computer-implemented method of claim 1, wherein the code conversion prompt comprises a reference to the decision tree and contextual data for the computer programmable code that identifies at least one of (i) a code sample, (ii) a syntax library, or (iii) a code command.

4. The computer-implemented method of claim 3 further comprising determining the contextual data by:
generating, using an encoder, a prompt embedding based on the code conversion prompt;
accessing a plurality of contextual data embeddings that are associated with repository data;
determining a distance between the prompt embedding and each of the plurality of contextual data embeddings; and
identifying a subset of the plurality of contextual data embeddings that are most similar to the prompt embedding based on the distance.

5. The computer-implemented method of claim 1 further comprising:
generating, using the machine learning model, a test case for the computer programmable code;
executing the computer programmable code in accordance with the test case to generate a test result; and
responsive to the test result satisfying a testing criterion, transmitting the instructions to install the computer programmable code.

6. The computer-implemented method of claim 5, wherein generating the test case further comprises:
generating, using the machine learning model, a target synthetic population based on the set of standards; and
generating, using the machine learning model, a population query for the target synthetic population.

7. The computer-implemented method of claim 1 further comprising:
receiving a decision tree validation response indicating a deviation between the decision tree and the set of standards; and
re-generating the decision tree based on using at least a portion of the decision tree validation response as input.

8. The computer-implemented method of claim 1 further comprising:
detecting from a set of data sources that the text-based file has newly been added to or modified at one of the set of data sources; and
receiving the text-based file based on identifying the text-based file as a new or modified text-based file.

9. The computer-implemented method of claim 1 further comprising:
receiving a code validation response; and
in response to the code validation response identifying a deviation between the decision tree and the computer programmable code, re-generating the computer programmable code.

10. A system comprising:
one or more processors; and
at least one memory storing processor-executable instructions that, when executed by any one or more of the one or more processors, causes the one or more processors to perform operations comprising:
receiving a text-based file that defines a set of standards for a prediction domain;
generating, using a machine learning model, a decision tree based on (i) the text-based file and (ii) a decisioning prompt for the text-based file;
generating, using the machine learning model, computer programmable code for the set of standards based on the decision tree and a code conversion prompt for the decision tree; and
transmitting the computer programmable code and instructions to install the computer programmable code on one or more computing devices to automate a task for the prediction domain.

11. The system of claim 10, wherein the machine learning model comprises a pre-trained transformer-based machine learning model that is finetuned using a training dataset that comprises at least one of: (i) a historical text-based file, (ii) a historical decision tree corresponding to the historical text-based file, or (iii) historical computer programmable code corresponding to the historical text-based file.

12. The system of claim 10, wherein the code conversion prompt comprises a reference to the decision tree and contextual data for the computer programmable code that identifies at least one of (i) a code sample, (ii) a syntax library, or (iii) a code commands.

13. The system of claim 10, wherein the operations further comprise:
generating, using the machine learning model, a test case for the computer programmable code;
executing the computer programmable code in accordance with the test case to generate a test result; and
responsive to the test result satisfying a testing criterion, transmitting the instructions to install the computer programmable code.

14. The system of claim 13, wherein generating the test case comprises:
generating, using the machine learning model, a target synthetic population based on the set of standards; and
generating, using the machine learning model, a population query for the target synthetic population.

15. The system of claim 10, wherein the operations further comprise:
receiving a decision tree validation response indicating a deviation between the decision tree and the set of standards; and
re-generating the decision tree based on using at least a portion of the decision tree validation response as input.

16. The system of claim 10, wherein the operations further comprise:
detecting from a set of data sources that the text-based file has newly been added to or modified at one of the set of data sources; and
receiving the text-based file based on identifying the text-based file as a new or modified text-based file.

17. The system of claim 10, wherein the operations further comprise:
receiving a code validation response; and
in response to the code validation response identifying a deviation between the decision tree and the computer programmable code, re-generating the computer programmable code.

18. One or more non-transitory computer-readable storage media including instructions that, when executed by one or more processors, cause the one or more processors to perform operations comprising:
receiving a text-based file that defines a set of standards for a prediction domain;
generating, using a machine learning model, a decision tree based on (i) the text-based file and (ii) a decisioning prompt for the text-based file;
generating, using the machine learning model, computer programmable code for the set of standards based on the decision tree and a code conversion prompt for the decision tree; and
transmitting the computer programmable code and instructions to install the computer programmable code on one or more computing devices to automate a task for the prediction domain.

19. The one or more non-transitory computer-readable storage media of claim 18, wherein the code conversion prompt comprises a reference to the decision tree and contextual data for the computer programmable code that identifies at least one of (i) a code sample, (ii) a syntax library, or (iii) a code commands.

20. The one or more non-transitory computer-readable storage media of claim 18, wherein the operations further comprise:
generating, using the machine learning model, a test case for the computer programmable code;
executing the computer programmable code in accordance with the test case to generate a test result; and
responsive to the test result satisfying a testing criterion, transmitting the instructions to install the computer programmable code.
